(19) United States
(12) Patent Application Publication
(10) Pub. No.: US 2026/0289853 A1
(43) Pub. Date: Sep. 24, 2026

(54) SYSTEM

(71) Applicant: SoftBank Group Corp., Tokyo (JP)

(72) Inventor: Eisaku FUJIMOTO, Tokyo (JP)

(73) Assignee: SoftBank Group Corp., Tokyo (JP)

(21) Appl. No.: 19/560,278

(22) Filed: Mar. 9, 2026

(30) Foreign Application Priority Data
Mar. 19, 2025 (JP) 2025-045037

(51) Int. Cl. G06T 11/60; G06F 40/30; G06F 40/40; G06N 3/0455; G06N 3/0475; G06Q 30/0241; G06T 3/4046; G06T 11/10

(52) U.S. Cl. CPC G06T 11/60; G06F 40/30; G06F 40/40; G06N 3/0455; G06N 3/0475; G06Q 30/0276; G06T 3/4046; G06T 11/10

(57) ABSTRACT

A system includes a processor that is configured to receive a request expressed in natural language, analyze the received request and generate a prompt sentence for instructing a generative AI model to generate a visual material, transmit the generated prompt sentence to the generative AI model, and cause the generative AI model to generate a visual material based on the request.

### CROSS-REFERENCE TO RELATED APPLICATION

This application is based on and claims priority under 35 USC 119 from Japanese Patent Application No. 2025-045037 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for creating visual materials for use in documents, presentations, advertisements, and design works generally require a user to manually operate complex design tools or to commission work to professional designers. Such techniques require specialized skills, substantial time, and significant cost. Furthermore, when a user intends to utilize generative AI models to automatically create visual materials, the user is often required to construct suitable prompts or parameter sets in a technical format that is not intuitive for non-expert users. As a result, it is difficult for ordinary users to obtain visual materials that accurately reflect their intent based solely on natural language expressions. In addition, even when visual materials are automatically generated by a generative AI model, the generated results are not necessarily optimized for specific use cases such as information creation or design work, and additional manual editing or customization is frequently required. Therefore, there is a need for a system that can accept a request expressed in natural language, automatically generate a prompt appropriate for a generative AI model, cause the generative AI model to generate visual materials based on the user request, and further customize and optimize the generated visual materials so as to improve work efficiency in information creation and design work.

### SUMMARY

In order to solve the above problem, according to one aspect of the present invention, there is provided a system comprising a processor, wherein the processor is configured to receive a request expressed in natural language, analyze the received request, and generate a prompt sentence for instructing a generative AI model to generate a visual material. The processor is further configured to transmit the generated prompt sentence to the generative AI model and to cause the generative AI model to generate a visual material based on the request. In one embodiment, the processor is configured to input the prompt sentence to a specific generative AI model and to process data output from the generative AI model, thereby obtaining the visual material in a desired format. In another embodiment, the processor is configured to customize and optimize the generated visual material in accordance with a user request in order to improve work efficiency in information creation or design work. By these means, the system enables a user to obtain, through natural language input, visual materials that are suitable for commercial use and tailored to particular purposes, without requiring specialized knowledge of prompt construction or manual design operations.

The term “system” refers to an arrangement including at least one processor and, optionally, memory, storage, communication interfaces, and other hardware or software components that cooperatively execute the processing described in the claims.

The term “processor” refers to any hardware component or combination of hardware components capable of executing instructions, such as a central processing unit (CPU), graphics processing unit (GPU), digital signal processor (DSP), microcontroller, or a combination thereof, and may operate under the control of software, firmware, or hardwired logic.

The term “request expressed in natural language” refers to an instruction, demand, or description provided by a user using a human language, such as English or Japanese, without requiring a formal programming language, markup language, or predefined command syntax.

The term “analyze the received request” refers to processing the natural-language request to extract information such as objects to be depicted, styles, background conditions, constraints, or other attributes needed to construct a prompt or parameter set for a generative AI model.

The term “prompt sentence” refers to a text string or structured textual data generated from the analyzed request and formatted so as to be suitable for input to a generative AI model as an instruction for generating a visual material.

The term “generative AI model” refers to an artificial intelligence model, such as a machine learning or deep learning model, that is capable of generating new data, including images or other visual materials, in response to input data such as a prompt sentence.

The term “visual material” refers to an image, illustration, design, graphic, or other visual content that can be displayed, stored, or used in digital or printed media, including but not limited to photographs, drawings, icons, backgrounds, and composite graphics.

The term “transmit the generated prompt sentence” refers to sending the generated prompt sentence from the processor to the generative AI model, either within the same device or over a network, using an appropriate communication protocol or interface.

The term “cause the generative AI model to generate a visual material” refers to controlling or instructing the generative AI model, by providing the prompt sentence and associated parameters, so that the generative AI model performs a generation process and outputs data representing a visual material.

The term “specific generative AI model” refers to a particular generative AI model that is selected or predetermined for use by the system, which may be identified by type, version, provider, configuration, or execution environment.

The term “input the prompt sentence to a specific generative AI model” refers to supplying the prompt sentence, and optionally additional parameters, as input data to the specific generative AI model according to an interface specification or API of that model.

The term “process data output from the generative AI model” refers to performing operations on the data produced by the generative AI model, such as decoding, converting formats, resizing, cropping, filtering, compressing, or otherwise transforming the data into a usable visual material.

The term “customize the generated visual material” refers to modifying the generated visual material in response to a user request or predefined criteria, including but not limited to changing colors, layouts, sizes, compositions, annotations, or other visual attributes.

The term “optimize the generated visual material” refers to adjusting the generated visual material so that it becomes more suitable for a particular purpose, medium, or use case, such as improving readability, visual balance, resolution, file size, or compatibility with target applications.

The term “user request” refers to a requirement, preference, constraint, or instruction provided by a user, including both the initial natural-language request and any subsequent requests for customization or optimization of the visual material.

The term “work efficiency in information creation or design work” refers to the degree to which tasks related to preparing documents, presentations, advertisements, layouts, or other design-related outputs can be performed with reduced time, effort, cost, or required expertise, as compared to conventional methods.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

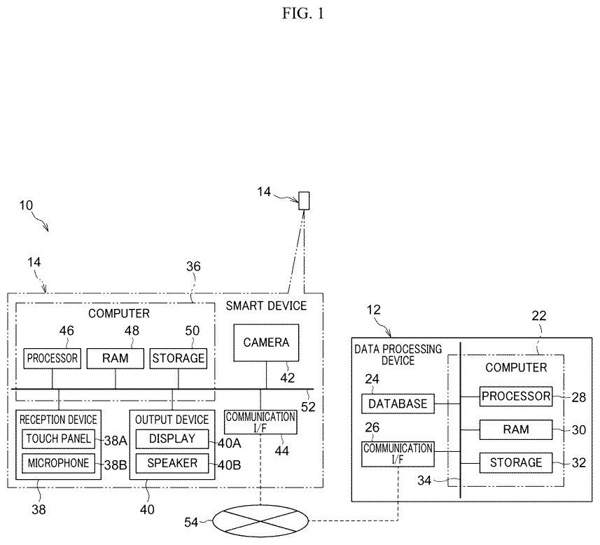

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

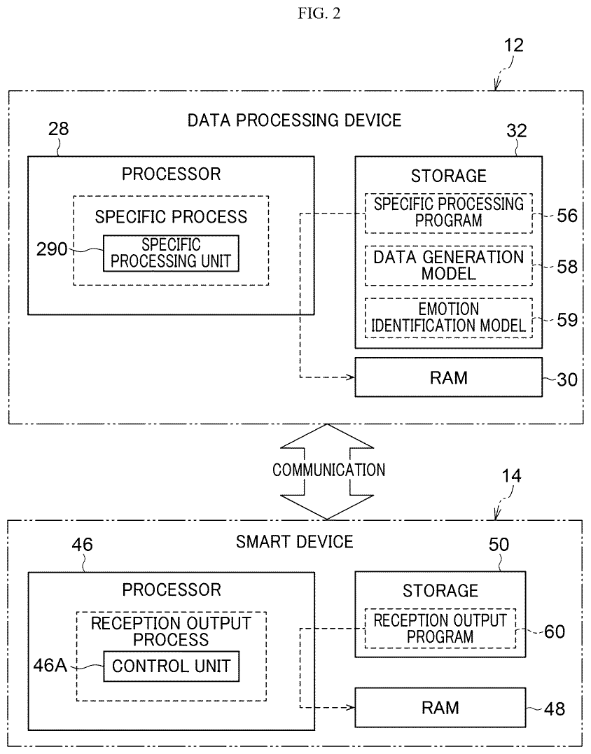

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented visual content generation systems that utilize a generative AI model typically accept a user instruction in natural language and pass that instruction directly, or with only superficial modification, to the generative AI model. In such architectures, a processor often performs only minimal parsing or keyword extraction, without performing deeper normalization of the request, without structuring the instruction into a prompt sentence that is optimized for the generative AI model, and without integrating downstream constraints such as commercial usage conditions, image specifications, or post-processing requirements into a unified control flow. As a result, the generative AI model frequently produces visual information that is incomplete, inconsistent with the user's actual intent, or unsuitable for commercial use, thus requiring extensive manual trial-and-error and manual editing by the user.

Furthermore, existing systems generally do not treat the generation pipeline as an integrated computer-technical process in which input analysis, prompt sentence construction, model invocation, and output post-processing are coordinated by the processor as a single optimized workflow. For example, a typical system does not systematically extract structured parameters such as target objects, attributes, representation style, and usage conditions from the natural-language request, and does not convert these parameters into machine-readable generation instruction information that explicitly controls both the generative AI model and subsequent image processing operations. This lack of structured, processor-level coordination leads to inefficient use of computational resources, inconsistent output quality, and an inability to reliably reproduce or adjust generated visual information based on prior interactions.

In addition, conventional systems rarely maintain a persistent correspondence among the original natural-language request, the internally generated prompt sentence, the resulting visual information, and the associated usage conditions in a recording unit. Without such structured associations, the processor cannot efficiently perform regeneration, modification, or multiple-candidate presentation of visual information. As a consequence, information creation tasks and design tasks that rely on iterative interaction with a generative AI model suffer from unnecessary computational overhead, duplicated processing, and degraded user experience.

Accordingly, there is a need for an improved computer-implemented system in which the processor is specifically configured to: (i) receive and analyze a natural-language request to extract structured parameters; (ii) generate a normalized, formatted prompt sentence as generation instruction information optimized for a generative AI model; (iii) invoke the generative AI model with the prompt sentence and image specification information; (iv) perform post-processing to convert generated visual information into a commercially usable format; and (v) record and exploit correspondences among the request, the prompt sentence, the visual information, and usage conditions. By technically improving the way the processor orchestrates the end-to-end generation pipeline, it becomes possible to enhance the reliability, efficiency, and reproducibility of computer-implemented visual information generation.

The specific processing by the specific processing unit 290 of the data processing device 12 in Example 1 is realized by the following means.

The present invention provides a server comprising a processor configured to receive, via a network, a request expressed in natural language from a user terminal; analyze the request expressed in natural language to extract at least a target, an attribute, a representation style, and a usage condition included in the request; normalize a generation language expression based on an extraction result; generate a prompt sentence for generation processing by applying a predetermined format to the generation language expression; generate generation instruction information including the prompt sentence for generation processing and image specification information; input the generation instruction information to a generative information processing model so as to cause the generative information processing model to generate visual information; obtain the visual information output from the generative information processing model; perform post-processing by converting at least a color space, a pixel count, a resolution, and a recording format of the visual information into a commercially usable format in accordance with the usage condition; store the post-processed visual information in a storage device; and manage information relating to the request expressed in natural language and the prompt sentence in association with the visual information so as to provide the visual information to the user terminal in a downloadable form. This enables a computer-implemented improvement in the generation pipeline by allowing the processor to systematically transform unstructured natural-language input into structured generation instruction information, to invoke the generative AI model under explicit control of image specifications and usage conditions, and to automatically produce, store, and reuse commercially usable visual information with reduced manual intervention and improved efficiency in information creation and design tasks.

The term “request expressed in natural language” refers to an instruction, demand, or description provided by a user using a human language, without requiring a predefined command syntax or structured markup.

The term “user terminal” refers to an information processing device operated by a user, such as a computing apparatus or communication apparatus, that is capable of transmitting the request expressed in natural language to a server and receiving visual information from the server via a network.

The term “network” refers to a communication infrastructure, including wired or wireless communication paths and associated communication protocols, that enables data exchange between the user terminal and the server.

The term “processor” refers to one or more hardware circuits, such as a central processing unit, graphics processing unit, digital signal processor, or other computation unit, configured to execute computer-readable instructions to implement the functions described herein.

The term “generation language expression” refers to a representation of the content of the request expressed in natural language that has been analyzed and reformulated into a machine-interpretable textual form suitable for controlling a generative information processing model.

The term “prompt sentence” refers to a textual instruction generated by the processor by applying a predetermined format to the generation language expression, the textual instruction being configured for input to a generative information processing model to cause generation of visual information.

The term “generation instruction information” refers to structured information including at least the prompt sentence and one or more parameters such as image specification information, the structured information being used to control operation of a generative information processing model.

The term “image specification information” refers to data indicating one or more attributes of desired image output, including at least one of size, resolution, aspect ratio, color mode, style, or file format.

The term “generative information processing model” refers to a machine-implemented model, such as a statistical model or neural network model, configured to receive input information including text and to generate new information, such as visual information, that is not merely a retrieval of stored data.

The term “visual information” refers to digital data representing a visual content item, such as an image, illustration, graphic, or similar two-dimensional representation that can be displayed on a display device or stored in an image file.

The term “usage condition” refers to a constraint or requirement associated with the use of the visual information, including at least one of commercial use, non-commercial use, distribution condition, resolution requirement, or file format requirement.

The term “post-processing” refers to processing performed by the processor on visual information generated by the generative information processing model, including at least one of conversion of color space, adjustment of pixel count, modification of resolution, and conversion of a recording format, in order to satisfy a usage condition.

The term “commercially usable format” refers to a representation of visual information that satisfies one or more technical conditions for use in a commercial context, including at least one of a specified resolution, a specified color space, a specified recording format, or embedded metadata indicating usage rights.

The term “storage device” refers to a physical or logical storage resource, such as a memory, magnetic storage, or solid-state storage, configured to store visual information, requests, prompt sentences, or associated metadata.

The term “recording unit” refers to a functional component, implemented by a storage device and controlled by the processor, that is configured to record and maintain associations among a request expressed in natural language, a prompt sentence, visual information, and a usage condition.

The term “correspondence” refers to an association or mapping stored by the recording unit between at least two items selected from a request expressed in natural language, a prompt sentence, visual information, and a usage condition, such that the items can be retrieved or processed in relation to one another.

The term “regeneration” refers to a process in which the processor causes the generative information processing model to newly generate visual information based on previously stored correspondence, without requiring the user to reenter an equivalent request expressed in natural language.

The term “modification” refers to a process in which the processor generates updated visual information by changing at least one of the prompt sentence, the image specification information, or the usage condition associated with previously generated visual information.

The term “multiple-candidate presentation” refers to a process in which the processor provides two or more different pieces of visual information to the user terminal, each piece having been generated based on the same or related correspondence, to allow selection or comparison by the user.

In one embodiment, a server implements the claimed system as a network-connected information processing apparatus including at least one central processing unit (CPU), at least one graphics processing unit (GPU), a main memory, a non-volatile storage device, and a network interface. The server executes an operating system such as a general-purpose server operating system and runs application software modules that implement natural-language analysis, prompt sentence generation, generative AI model control, image post-processing, and data management. A terminal is implemented as a computing device such as a smartphone, tablet, or personal computer, equipped with a display device, an input device, a local storage, and a communication module capable of accessing the server via a wired or wireless network. A user operates the terminal to interact with the server and to obtain visual information generated by a generative AI model.

Server executes an application that exposes a network application programming interface (API) and a user interface for the terminal. When the terminal connects to the server, the server provides, for example, a web page rendered in a browser or a graphical interface in a native application. The terminal presents an input control such as a text input field to the user. User inputs a request expressed in natural language describing desired visual information. For example, user may input the following text:

“Generate an illustration with a bright blue sky and fluffy white clouds in a clean, high-resolution style.”

or

“Generate a high-resolution landscape illustration with a vivid blue sky and soft white clouds, suitable for commercial use.”

or

“Create a fantasy-style illustration of a castle at night under a starry sky, with rich colors and detailed lighting effects.”

Terminal transmits the natural-language request to the server over the network using a structured message format. Server receives the request via the network interface and stores the request in the main memory. Server also stores the request in a storage device as part of a request record that includes a user identifier, timestamp, and initial status indicator.

Server executes a natural-language analysis module implemented as a software component running on the CPU. This module uses a trained language encoder based on a neural network architecture such as a transformer, implemented using a machine-learning framework, to convert the natural-language request into a sequence of token embeddings. The neural network includes multiple layers of self-attention, feedforward sublayers, layer normalization, and positional encoding. Server loads the trained model parameters, including weight matrices and bias values, from the storage device into memory and applies them to the input tokens.

Server analyzes the token embeddings to extract structured parameters such as a target (for example, “landscape”, “castle”, “sea”), attributes (for example, “blue”, “red sunset”, “calm”, “fantasy-style”), representation style (for example, “illustration”, “watercolor”, “cartoon”), and usage conditions (for example, “commercial use”, “web banner”, “print at 300 dpi”). The natural-language analysis module implements a classification layer and one or more attention mechanisms that map the hidden representations to a fixed set of semantic categories. The processor thereby performs a technical transformation of unstructured text into structured feature vectors that represent generation parameters.

Server normalizes the extracted parameters into a generation language expression. In this normalization, the server converts synonyms and informal phrases into canonical forms and resolves ambiguities according to predefined rule sets stored in the storage device. For example, if user writes “high quality for printing”, server converts this into a combination of “resolution: 4096×4096 pixels” and “dots per inch: 300 dpi”, and if user writes “for a website header”, server converts this into a specific aspect ratio such as “16:9” and a maximum pixel width. The server applies a rule-based mapping engine that uses lookup tables and priority rules to map linguistic expressions to parameter values. By executing these operations, the processor performs more than mere keyword extraction; it computes structured, machine-interpretable control data for downstream hardware-accelerated image generation and post-processing.

Server generates a prompt sentence based on the normalized generation language expression. The server uses a prompt generation module that combines the canonical content descriptors with a predetermined sentence template tuned for the generative AI model. For example, the server produces a prompt sentence such as:

“Generate a high-resolution landscape illustration with a vivid blue sky and soft white clouds, suitable for commercial use.”

or

“Generate a fantasy-style illustration of a castle at night under a starry sky, with rich colors and detailed lighting effects.”

or

“Generate a minimalistic flat-design camera icon with clear outlines, optimized for mobile app usage.”

The prompt generation module uses deterministic concatenation rules and optional language smoothing via a smaller language model. Server records both the original natural-language request and the generated prompt sentence in the storage device as part of a correspondence record, which also includes the extracted parameters such as target, attributes, representation style, and usage conditions. This creates a structured data graph in which each request is linked to one or more prompt sentences and corresponding outputs.

Server constructs generation instruction information that includes the prompt sentence and image specification information. The image specification information includes pixel dimensions, aspect ratio, color space, and output image format. For example, if the usage condition indicates commercial printing, server sets the image specification information to 4096×4096 pixels, square aspect ratio, sRGB color space, and a lossless format such as PNG. If the usage condition indicates web use, server may set a lower resolution and a compressed format. Server stores this generation instruction information in memory as a record including fields for prompt sentence, width, height, color space, and format. This record is passed to a generative AI model control module.

Server interfaces with a generative AI model implemented as a text-to-image generative neural network. The generative AI model typically consists of a text encoder and an image generator, for example a diffusion model. The text encoder applies a transformer architecture to convert the prompt sentence into a latent text representation. The diffusion model operates in a latent space, where the model starts from sampled noise vectors and iteratively denoises them according to the encoded prompt. The model parameters (weights) are pre-trained on a large dataset of text-image pairs. Server loads the model parameters into the GPU memory. The GPU executes the forward pass of the generative AI model, performing parallel matrix multiplication and convolution operations to generate latent feature maps and finally image tensors.

Server supplies the prompt sentence and image specification information as inputs to the generative AI model. Internally, the control module maps the resolution specified in the image specification information to an appropriate latent space resolution and configures the number of denoising steps, guidance scale, and random seed. The number of steps and guidance scale are stored as configuration parameters in the storage device and are retrieved based on usage condition or user preferences. The server thus modifies the internal sampling procedure of the generative AI model in a systematic manner, rather than simply passing text, thereby improving the trade-off between inference time and output quality.

Server receives the generated visual information from the generative AI model as an image tensor in memory. The GPU writes the tensor to the main memory, where the CPU processes it using an image processing library. The server first converts the image tensor into a standard image buffer in a base color space. The server then applies post-processing steps that include color space conversion, resizing, and format conversion. For example, the server uses an image processing library to convert from a generic floating-point RGB representation to an sRGB integer-based representation, applies resampling filters to adjust pixel dimensions, and writes the result to a PNG or JPEG file in the storage device. The server also writes metadata to the file, such as creation timestamp, intended usage conditions, and an identifier linking back to the request and prompt sentence.

Server stores the post-processed visual information in a storage device such as a disk array or object storage system. The server associates the file path or object identifier with the corresponding request record and prompt sentence in a database. The database schema includes tables for requests, prompt sentences, generated images, and usage conditions, connected by foreign keys. By maintaining these correspondences, the server can later retrieve all visual information generated from a particular request or can re-invoke the generative AI model with modified parameters without repeating the entire analysis from raw text.

Server manages the stored correspondence to enable regeneration, modification, and multiple-candidate presentation. For regeneration, the server retrieves the stored prompt sentence and image specification information and instructs the generative AI model to generate a new image, potentially with a different random seed or updated configuration parameters. For modification, the server adjusts one or more parameters, such as changing the resolution or style attributes in the generation instruction information, and regenerates. For multiple-candidate presentation, the server configures the generative AI model to generate multiple images for a single prompt, or to slightly perturb the prompt sentence or model parameters across several inference runs. The server registers each generated image with its own record and links them to the original request, enabling the terminal to display multiple options.

Terminal receives, from the server, identifiers or network locations of the generated visual information. Terminal retrieves the generated images via standard network protocols and displays them on the display device. User reviews the images and may select one or more for download. When the user initiates a download, the terminal writes the selected images to local storage, preserving the commercial-use-ready image format established by the server. This configuration leads to technical improvements in computer operation. Because the server extracts structured parameters and normalizes the generation language expression, the server reduces the number of iterations needed to reach an acceptable output, thereby reducing total GPU inference time and network traffic. By separating the prompt sentence and image specification information, the server can reuse the same prompt with different resolutions or formats without repeating the linguistic analysis, which increases throughput and decreases CPU load. The explicit control of color space and resolution in the post-processing pipeline reduces the need for external editing software and ensures that images meet technical constraints automatically, improving the reliability of downstream printing or rendering devices.

In one variant embodiment, the server applies a caching mechanism. When the server detects that the same or substantially similar prompt sentence and image specification information have been used previously, the server retrieves an existing visual information file instead of re-invoking the generative AI model. The caching mechanism compares hashed representations of the generation instruction information and determines a cache hit according to a similarity threshold. This reduces redundant GPU computation and lowers energy consumption, which is a technical effect not achievable by mere human repetition. In another embodiment, the server uses an auxiliary model to predict optimal generation parameters from the structured features extracted from the natural-language request. This auxiliary model, implemented as a feedforward neural network, receives feature vectors representing target, attributes, and usage conditions and outputs recommended values for resolution, number of diffusion steps, and guidance scale. The server then uses these recommended parameters when constructing the generation instruction information. This improves computational efficiency by avoiding overly conservative default settings and reduces artifacts by tuning parameters to content characteristics.

In yet another embodiment, the server adjusts communication payload sizes according to the extracted usage conditions. When the server determines that only a low-resolution preview is needed initially, the server instructs the generative AI model to generate a reduced-resolution image and sends only the preview image to the terminal. If user later requests a high-resolution version, the server generates a higher resolution using the same prompt sentence and image specification information. This staged approach reduces initial communication load and speeds up user feedback while still preserving the ability to obtain high-quality outputs, thereby optimizing network resource usage.

The generative AI model is trained in advance using a large dataset of text-image pairs. During training, the server (or another training system) performs supervised learning in which the text encoder maps textual descriptions to embeddings and the image generator maps noise to images conditioned on these embeddings. The training process uses a loss function that measures the difference between generated images and ground-truth images, for example using a combination of pixel-wise losses and perceptual losses. The training optimizer updates model weights using methods such as stochastic gradient descent or adaptive gradient algorithms. The training also employs data augmentation techniques such as random cropping, resizing, color jittering, and text perturbation to improve generalization. Because the trained model parameters are used at inference time by the server, the inference procedure benefits from the rich feature representation learned during training, enabling the server to generate images that more accurately reflect complex natural-language requests.

The server's integration of detailed prompt sentence construction, structured image specification information, and deterministic post-processing rules constitutes more than mere automation of human workflow. A human operator cannot directly perform transformer-based embedding, diffusion-based latent sampling, or GPU-accelerated image resampling at the scale and speed enabled by the server. The architecture exploits specific computer capabilities vectorized computation, large memory, high-throughput I/O, and structured storage to implement a pipeline that reduces latency, improves correspondence accuracy between request and visual output, and ensures consistent technical quality across different usage conditions. By controlling the generative AI model and the post-processing pipeline via explicit, machine-interpretable generation instruction information, the server changes how the computer allocates computational resources and how it manages data dependencies within the generation process, thereby improving the functioning of the computer system itself.

Although several embodiments and variations have been described, the server can modify individual modules without departing from the scope of the claims. For example, the natural-language analysis module can use different neural network architectures, such as recurrent networks or convolutional sequence models; the generative AI model can be a generative adversarial network or an autoregressive image generator instead of a diffusion model; and the post-processing module can incorporate additional operations such as watermarking or vectorization, as long as the core process of generating visual information from a prompt sentence and image specification information, and converting the result into a commercially usable format, is maintained. The terminal can also be implemented as various types of client devices, including head-mounted displays or embedded controllers, as long as the terminal is capable of transmitting a request expressed in natural language and receiving visual information from the server.

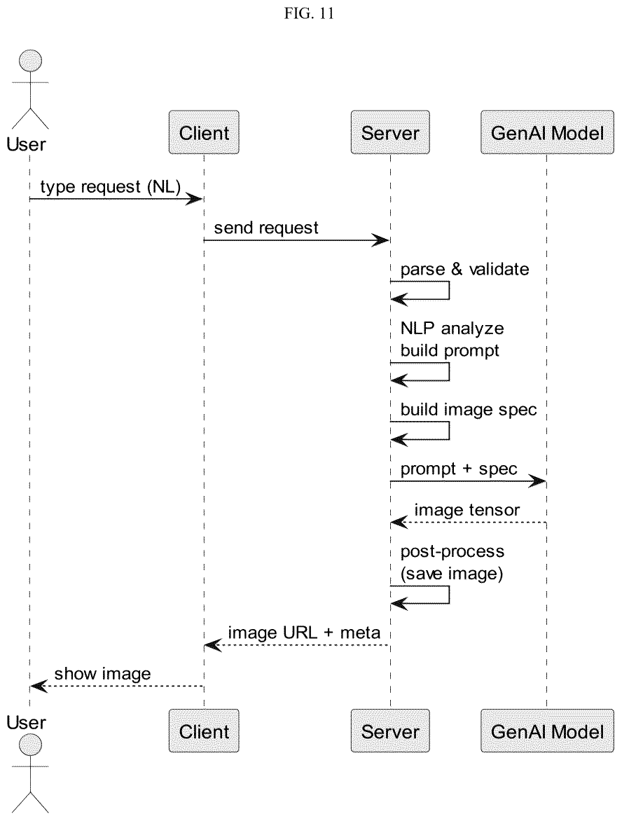

The following describes the processing flow using FIG. 11.

### Step 1

User operates the terminal and inputs a request expressed in natural language.

User views an input screen displayed by the terminal, such as a text field and a “Generate” button, and types a sentence describing desired visual information (input: raw natural-language text). User, for example, inputs “Generate a high-resolution landscape illustration with a vivid blue sky and soft white clouds, suitable for commercial use.”

Terminal captures this text as a character string, optionally attaches user identification and device information, and constructs a request message. Terminal sends the request message to the server via a network connection using a communication protocol (output: structured request message containing the natural-language text).

### Step 2

Server receives and validates the request message.

Server accepts the incoming message from the terminal through a network interface (input: structured request message). Server parses the message to extract the natural-language text, user identifier, and any auxiliary parameters. Server performs validation operations such as checking that the text is non-empty, within a permissible length, and free from invalid encoding. Server stores the validated text and metadata in a request record in a storage device (output: stored request record and in-memory representation of the natural-language text ready for analysis).

### Step 3

Server performs natural-language analysis and parameter extraction.

Server applies a language analysis module to the in-memory text (input: natural-language text). Server tokenizes the text into subword units, converts them into numerical token IDs, and feeds the token IDs into a neural-network encoder such as a transformer encoder. Using matrix multiplication and attention mechanisms, server computes embedding vectors and hidden states representing semantic content. Server then applies classification layers and rule-based mapping tables to identify a target (for example, “landscape”), attributes (for example, “vivid blue sky”, “soft white clouds”), representation style (for example, “illustration”), and usage conditions (for example, “high-resolution”, “commercial use”). From these computations, server outputs a structured parameter set containing fields such as target type, color descriptors, style type, resolution requirement, and usage condition (output: structured parameter set derived from the natural-language text).

### Step 4

Server normalizes the parameter set into a generation language expression.

Server takes the structured parameter set as input (input: extracted parameters) and applies normalization rules stored in a rule database. Server replaces synonyms with canonical terms, resolves ambiguous expressions (for example, interpreting “high quality for printing” as “4096×4096 pixels, 300 dpi”), and maps qualitative terms (for example, “large”, “small”) to numerical values according to predefined thresholds. Server combines normalized values into an intermediate textual representation that explicitly describes the content and technical requirements (for example, “landscape illustration, vivid blue sky, soft white clouds, 4096×4096 pixels, 300 dpi, commercial use allowed”). Through these data transformations, server outputs a normalized generation language expression that is machine-interpretable and free of informal variations (output: normalized generation language expression).

### Step 5

Server generates a prompt sentence from the generation language expression.

Server receives the normalized generation language expression (input: normalized expression) and applies a prompt generation module. Server concatenates canonical descriptors according to a template such as “[Verb phrase] [subject] with [attributes], [style], [technical constraints].” Server may optionally use a small language model to smooth grammar and word order, based on scoring candidate sentences and selecting the highest-scoring one. As a result of this string construction and selection process, server outputs a prompt sentence suitable for a generative AI model. For example, server generates:

“Generate a high-resolution landscape illustration with a vivid blue sky and soft white clouds, suitable for commercial use.” (output: finalized prompt sentence).

### Step 6

Server constructs generation instruction information including image specification information.

Server takes as input the prompt sentence and the structured parameter set (input: prompt sentence and parameters). Server computes numerical image specification information, such as width, height, aspect ratio, color space, and output format, by mapping usage conditions and style parameters to technical values (for example, 4096×4096 pixels, sRGB, PNG for commercial printing, or 1920×1080 pixels, sRGB, JPEG for web). Server aggregates the prompt sentence and image specification information into a generation instruction record, represented as a structured object in memory with fields for text prompt, resolution, color mode, and file format. This record is designed so that each field directly controls a corresponding setting of the generative AI model or post-processing module (output: generation instruction information ready for model invocation).

### Step 7

Server configures and invokes the generative AI model.

Server uses the generation instruction information as input (input: prompt sentence and image specification information) and configures a generative AI model, such as a text-to-image diffusion-based neural network. Server encodes the prompt sentence using a text encoder to obtain a latent text embedding, and maps the image specification information to internal parameters such as latent image size, number of denoising steps, and guidance scale. Server then executes the model on a GPU, which performs iterative denoising and gradient-based sampling operations in the latent space to generate an image tensor consistent with the text embedding. This computation transforms random noise plus semantic conditioning into a structured array of pixel values. When the model finishes inference, server retrieves the resulting image tensor from GPU memory (output: generated image tensor representing the visual information).

### Step 8

Server converts the image tensor into a standard image buffer and performs post-processing.

Server receives the image tensor (input: raw image tensor) and uses an image processing library to convert the tensor into a standard image buffer in a base color space. Server applies rescaling operations, using interpolation algorithms (for example, bicubic or Lanczos filters), to match exact pixel dimensions specified in the image specification information. Server converts the color representation to a target color space such as sRGB and sets metadata fields such as dpi according to the usage conditions. Server then encodes the image buffer into a file format such as PNG or JPEG, executing compression and encoding algorithms appropriate to the selected format. As a result, the server produces a binary image file that satisfies both the visual requirements and the technical conditions for commercial use (output: post-processed image file in a commercially usable format).

### Step 9

Server stores the image file and associated correspondence information.

Server takes as input the post-processed image file, the original request record, the prompt sentence, and the usage conditions (input: image file and associated metadata). Server writes the image file to a storage device, generating a unique identifier or file path. Server then updates a database to store a correspondence among the request expressed in natural language, the prompt sentence, the structured parameter set, the usage conditions, and the image identifier. This involves inserting records into tables and establishing foreign-key relationships or index entries. By this operation, server creates a retrievable mapping that allows future regeneration or modification without reprocessing the original natural-language request (output: persistent storage of the image and correspondence records).

### Step 10

Server prepares and transmits a response to the terminal.

Server uses the stored image identifier and metadata as input (input: image identifier, file location, and metadata). Server constructs a response message including a network location (for example, a URL) for the image file, the prompt sentence used for generation, and technical attributes such as width, height, format, and dpi. Server may also include information indicating that the image is available for commercial use based on the usage conditions. Server sends this response message over the network to the terminal (output: response message enabling the terminal to access and display the generated image).

### Step 11

Terminal receives, displays, and optionally downloads the generated image.

Terminal receives the response message from the server (input: response message with image location and metadata). Terminal parses the message to obtain the image location and attributes, then issues a request to retrieve the image file from the server or a storage service. Upon receiving the image data, terminal renders the visual information on the display using its graphics subsystem. Terminal may also provide a user interface element such as a “Download” button. When user activates this control, terminal writes the image file to local storage in the format and resolution determined by the server, enabling direct use in other applications without further technical conversion (output: displayed image and, if requested, locally stored image file).

### Step 12

Server supports regeneration, modification, and multiple-candidate presentation using stored correspondence.

Server later receives additional instructions from the terminal, such as a request to regenerate with a different style or resolution (input: regeneration or modification request referencing prior correspondence). Server queries the database using the stored correspondence to retrieve the original prompt sentence, structured parameters, and usage conditions. Server modifies or augments the generation instruction information according to the new request, for example by changing resolution or adding a new attribute such as “sunset lighting.” Server then repeats the model invocation and post-processing steps with the updated parameters to produce new image files. For multiple-candidate presentation, server generates several images using varied random seeds or slightly modified prompt sentences. Server stores these new images and updates the correspondence records, then sends identifiers and locations for the multiple images back to the terminal (output: regenerated, modified, or multiple candidate images linked to the original natural-language request).

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems that generate visual content based on user instructions suffer from several technical limitations. In typical architectures, a user must manually translate an abstract design intention into a highly structured prompt suitable for a generative image engine, and must repeatedly adjust low-level parameters through trial and error. This causes inefficiency in the utilization of computational resources, such as repeated, unnecessary invocations of generative models and redundant network traffic between a user device and a server. Moreover, existing systems generally treat the text input, prompt generation, and image generation as independent stages without an integrated, iterative feedback loop based on natural language, resulting in fragmented processing pipelines and increased latency.

In addition, many conventional systems are not optimized for handling voice input in a unified manner together with text input. When speech recognition is bolted on as a separate pre-processing component, the resulting architectures typically require the user device to perform substantial local processing and manual formatting of the recognized text, which leads to inconsistent prompt structures and degraded quality of the generated images. This fragmentation also complicates error handling and adaptation to user feedback, thereby wasting computation on the server side due to misaligned or ambiguous prompts.

Furthermore, conventional generative systems often do not maintain a coherent internal representation tying together the original user request, subsequent modification requests, and the corresponding prompts and generated images. As a result, when a user requests modifications, the system frequently regenerates content from scratch, without effectively reusing contextual information or prior computations. This leads to increased processing time, unnecessary execution of generative AI models, and higher consumption of computing resources such as central processing units, graphics processing units, memory, and network bandwidth.

There is accordingly a need for a computer-implemented technique that improves the underlying computer technology of visual content generation by (i) unifying voice and text input into a normalized text representation, (ii) automatically generating and updating structured prompt sentences suitable for generative AI models, and (iii) establishing an iterative server-controlled loop that efficiently regenerates visual content in response to natural language feedback. Such a technique should reduce redundant computation, improve throughput and latency of the generative pipeline, and provide a more efficient use of hardware and software resources in a client server environment.

The specific processing by the specific processing unit 290 of the data processing device 12 in Application Example 1 is realized by the following means.

The present invention provides a server comprising a processor configured to receive, via a terminal, a request in natural language input by a user and acquire the request as text information, analyze the text information and, using a generative language model, generate a prompt sentence for causing a visual representation to be generated in response to the request, input the prompt sentence to a generative image model that performs image generation or design generation and control the generative image model to generate visual representation data based on the prompt sentence, convert the visual representation data into a commercially usable format by using image processing software to convert at least one of a file format, a resolution, and metadata of the visual representation data and generate visual material data of a predetermined output format, transmit the visual material data to the terminal and cause the terminal to output the visual material data in a display format that is presentable to the user, acquire, via the terminal, a modification request in natural language from the user regarding the visual material data, update the prompt sentence based on the modification request, and perform a regeneration process by the generative image model so as to iteratively update the visual representation, and, in some embodiments, further configured to convert audio data into character data by using speech recognition software and to use the character data as the text information to be input to the generative language model, and to generate a combined description from the original request and the modification request and regenerate the visual representation data based on a prompt sentence derived from the combined description. This enables an integrated, server-centric processing pipeline in which heterogeneous natural language inputs are normalized, transformed into optimized prompt sentences, and iteratively refined in response to user feedback, thereby reducing redundant invocations of generative models, lowering overall computational and network overhead, and improving the efficiency and technical performance of computer resources used for visual content generation.

The term “processor” refers to a hardware computing element, such as a central processing unit, a graphics processing unit, or a programmable logic device, or a combination thereof, that executes instructions to perform data processing operations described in the present specification.

The term “terminal” refers to a user-operated computing device, such as a mobile device, a wearable device, a personal computer, or a display device, that provides an input/output interface between a user and a server.

The term “user” refers to a human operator who interacts with the system through the terminal by providing input in natural language and receiving visual material data.

The term “natural language” refers to a human language expression, spoken or written, that is not constrained to a formal programming syntax and that is interpretable by a natural language processing component.

The term “request” refers to an instruction or requirement expressed by the user in natural language for generating or modifying a visual representation.

The term “text information” refers to character-based digital data representing the content of the user's request, including data obtained directly from text input or converted from audio input.

The term “audio data” refers to digital data representing sound, including spoken utterances captured by a microphone and encoded in one or more audio formats.

The term “speech recognition software” refers to a software component or service that analyzes audio data containing speech and converts the speech into corresponding character data.

The term “generative language model” refers to a machine learning model, such as a neural network trained on language data, that generates or transforms text based on input text, including generation of a prompt sentence from text information.

The term “prompt sentence” refers to a structured text instruction derived from the user's request and used as input to a generative image model to control the generation or regeneration of a visual representation.

The term “generative image model” refers to a machine learning model, such as a generative neural network, that generates visual representation data based on at least one text input including a prompt sentence.

The term “visual representation data” refers to digital data representing a visual output, such as an image, a graphic, or a design layout, generated by the generative image model.

The term “visual material data” refers to visual representation data that has been converted into a predetermined output format suitable for presentation or commercial use.

The term “commercially usable format” refers to a data format, including at least one of a file type, a resolution, and metadata configuration, that satisfies predetermined requirements for distribution, publication, or commercial exploitation.

The term “image processing software” refers to a software component or library that performs at least one operation on visual representation data, including format conversion, resolution change, compression, or metadata editing.

The term “metadata” refers to auxiliary information associated with visual representation data or visual material data, including at least one of author information, copyright information, usage conditions, color profile, or creation parameters.

The term “display format” refers to a data structure or rendering configuration that enables the terminal to output visual material data on a display device in a manner perceivable by the user.

The term “modification request” refers to a subsequent natural language instruction provided by the user after presentation of visual material data, the instruction specifying at least one change to the generated visual representation.

The term “description” refers to a combined text, generated by the processor, that integrates the original request and at least one modification request and that serves as a basis for creating or updating a prompt sentence.

The term “regeneration process” refers to processing in which the generative image model generates updated visual representation data based on an updated prompt sentence derived from at least one modification request.

The term “iteratively update” refers to repeatedly performing generation and regeneration processes based on successive modification requests, such that the visual representation is progressively refined.

In one embodiment, a server cooperates with one or more terminals operated by a user to implement a visual content generation system that uses a generative AI model. The server includes at least one processor, a main memory, a non-volatile storage device, and a network interface. The terminal includes at least one processor, a memory, a display unit, an audio input device such as a microphone, an input device such as a touchscreen or keyboard, and a wireless or wired communication interface. The server and the terminal are connected via a communication network that may include the Internet, a cellular network, or a local area network.

The terminal executes an application program that presents a graphical user interface to the user. The terminal captures a request in natural language from the user. The user operates the terminal to provide the request either as voice or as text. When the user speaks into the microphone, the terminal acquires audio data as a time-series of sampled sound pressure values and stores the audio data in a buffer in memory. The terminal executes speech recognition software that segments the audio signal, extracts acoustic features such as Mel-frequency cepstral coefficients, and applies a trained acoustic model and language model to convert the audio data into character data. When the user types on the touchscreen or keyboard, the terminal generates a text string in memory. In both cases, the terminal normalizes the text by unifying character encoding, removing invalid control codes, and optionally correcting spelling or simple grammatical errors using a local text normalization module.

The terminal constructs a data structure in memory that includes a user identifier, a language code, and the normalized text string representing the user's request. The terminal transmits this data structure to the server via the network interface using a secure communication protocol. The terminal thereby reduces the processing load on the server by pre-normalizing heterogeneous input modalities into a single text representation.

The server receives the data structure through the network interface and stores it temporarily in memory. The server then invokes a natural language processing module that executes on the processor. The natural language processing module includes a generative language model, which in one embodiment is implemented as a transformer-based neural network with multiple encoder-decoder layers, multi-head self-attention mechanisms, and feed-forward sublayers. The server tokenizes the normalized text into subword tokens using a predefined tokenizer and converts the tokens into numerical embeddings by table lookup in an embedding matrix stored in memory.

The server processes the embeddings through the layers of the generative language model. Each layer computes attention weights between tokens, performs matrix multiplications, adds residual connections, and applies non-linear activation functions. The server controls the model parameters, such as the number of attention heads, the dimensionality of embeddings, and the depth of layers, in accordance with available hardware resources such as a graphics processing unit attached to the server. The server uses the generative language model to generate a prompt sentence that is more detailed and structured than the original user request. The generated prompt sentence encodes information such as required colors, layout, style, and embedded text.

For example, when the user request is:

“Create a bright banner for a summer sale with 50% OFF text.” the server generates a prompt sentence such as:

“A bright, colorful web banner for a summer sale, using warm yellow and orange tones, with large bold text ‘50% OFF’ centered in the layout, a clean modern design, and space for a company logo in the top right corner.”

In another example, when the user request is:

“Please create a banner that includes text such as ‘Summer Sale,’ ‘bright colors,’ and ‘50% off’”

the server generates a prompt sentence such as:

“A bright web banner for a summer sale with vivid warm colors, including large bold text ‘50% OFF’ and a simple, clean layout suitable for an online store homepage.”

The server then applies a formatting module that normalizes the prompt sentence into a representation that is optimized for input to a generative image model. The server may add explicit tags or keywords such as “high resolution”, “aspect ratio 16:9”, or “minimalist style” to the prompt sentence. By performing these operations centrally on the server, the system reduces the need for manual prompt engineering by the user and ensures that prompts conform to a consistent structure that improves model behavior.

The server next controls a generative image model to create visual representation data based on the prompt sentence. In one embodiment, the generative image model is implemented as a diffusion-based neural network. The server encodes the prompt sentence into a text embedding using a separate text encoder network. The server then initializes a latent variable representing an image as random noise in a high-dimensional latent space. The server iteratively refines this latent variable by applying a denoising network conditioned on the text embedding. Each denoising step involves convolutional operations, attention mechanisms, and non-linear activations. The server schedules the noise levels according to a predetermined diffusion schedule and computes gradients and updates within each inference pass to move from a random noise distribution toward an image that is semantically aligned with the prompt sentence.

The server decodes the final latent variable into an image in pixel space using a decoder network such as a variational autoencoder decoder. The server thereby obtains visual representation data as a multidimensional array of pixel values. The server then uses image processing software executing on the processor to convert the visual representation data into visual material data suitable for commercial use. The server may use software components corresponding to known image manipulation tools to perform operations such as color space conversion to a standard profile, conversion of the pixel array into a portable network graphics format, resizing to a predetermined resolution, and embedding metadata such as creation date and licensing information in the file header.

The server stores the visual material data in non-volatile storage and associates it with identifiers that also reference the original user request and the generated prompt sentence. The server then transmits the visual material data to the terminal, along with metadata that indicates recommended usage, such as “web banner 1200×628” or “social media post 1080×1920”. The terminal receives the visual material data, stores it in local memory, and renders it on the display using a rendering engine. The terminal displays the image to the user at an appropriate size and resolution, and displays the corresponding prompt sentence so the user can understand how the image was generated.

The user reviews the displayed image and, if desired, provides a modification request in natural language. For example, the user may state:

“Change the background to blue and move the ‘50% OFF’ text to the center.” or:

“Please set the background to blue and place the text ‘50% OFF’ in the center.”

The terminal captures this modification request in the same manner as the initial request, using speech recognition software or text input, and transmits normalized text to the server. The server retrieves the stored prompt sentence and visual material data associated with the previous generation. The server generates a combined description by merging the original request and the modification request into a single text input. The server again uses the generative language model to produce an updated prompt sentence. For example, the server may generate:

“A bright web banner for a summer sale with a vivid blue background, large bold text ‘50% OFF’ centered in the middle, and accent colors in light yellow for contrast.”

The server then repeats the generative image model inference using the updated prompt sentence, but in some embodiments, the server uses the previous latent representation or image as an initialization point. By reusing internal representations, the server reduces the number of inference steps required to converge to a new image, thereby improving processing speed and reducing computation cost. The server thus iteratively updates the visual representation data in response to successive natural language modification requests.

By managing the natural language processing, prompt sentence generation, and image generation in an integrated server-side pipeline, the system improves computer technology in several ways. First, the server reduces redundant invocations of the generative image model by generating structurally consistent prompt sentences that more accurately reflect user intent, thereby decreasing the number of trial-and-error generations. Second, the server optimizes network usage by transmitting compact text representations and identifiers instead of large image data whenever possible, for example when only a textual modification request is communicated. Third, the server organizes the data in structured records that link user requests, prompt sentences, model parameters, and generated images, improving data management and enabling more efficient caching and reuse of intermediate results.

The server implements training and adaptation of the generative language model and the generative image model in a separate training environment. The server stores training data consisting of pairs of user-style requests and optimized prompt sentences. The server defines a loss function such as cross-entropy over token sequences and uses gradient-based optimization, for example stochastic gradient descent or an adaptive method, to update the weights of the neural network. In one embodiment, the server performs fine-tuning on a pre-trained transformer language model with additional layers tailored to the domain of visual design descriptions. The server may also perform data augmentation by paraphrasing requests, injecting synonyms, or varying layout descriptions to make the model robust to diverse user expressions.

Similarly, the server trains or fine-tunes the generative image model with image-text pairs that include rich prompt sentences. The server defines a loss function that may combine a reconstruction term, a regularization term, and a perceptual quality term. During training, the server applies backpropagation to update the weights of the denoising network and the text encoder. By aligning the generative image model closely with the structured prompt sentences produced by the generative language model, the system improves the semantic fidelity of generated images and reduces artifacts, thereby improving accuracy relative to conventional systems.

The AI models in this system do not simply automate a human workflow; rather, they implement specific computational procedures that are not feasible for a human to perform in real time, such as large-scale matrix multiplications, high-dimensional attention computations, and iterative stochastic denoising in latent space. The server applies non-heuristic numerical algorithms to discover optimal or near-optimal configurations of latent features that correspond to user-intended designs. The server's control logic enforces non-conventional ordering of operations: conversion of heterogeneous input to normalized text, transformation of that text into a structured prompt sentence by a generative language model, and conditional image generation controlled by the structured prompt sentence. This architecture leads to reduced error rates in interpreting user intent and to faster convergence in the image generation process, which are technical improvements in the field of computer-implemented content generation.

In another embodiment, the server supports multiple types of generative image models, such as generative adversarial networks and encoder-decoder architectures, and dynamically selects a suitable model based on properties of the prompt sentence, such as requested style or resolution. The server may maintain a registry of models and associated performance statistics and choose a model that minimizes expected inference latency while satisfying quality constraints. The server can also adapt the number of inference steps or sampling parameters of the diffusion process according to the complexity of the prompt sentence, thereby further optimizing processing time and resource usage.

In yet another embodiment, the terminal performs part of the prompt sentence generation or image post-processing locally, for example when local processing capability is sufficient and network conditions are constrained. The server may transmit model parameters, compressed model components, or prompt templates to the terminal, enabling on-device inference under certain conditions. This variation reduces server load and network traffic and can improve responsiveness for the user, while still adhering to the same overall data structures and processing principles.

Across these embodiments, the server, the terminal, and the user interact through clearly defined data flows: the user provides natural language input, the terminal converts the input into normalized text and transmits it, the server generates and updates prompt sentences and visual representation data using trained neural network models, and the terminal presents the resulting visual material data. The particular combination of generative language modeling, structured prompt sentence generation, conditional generative image modeling, and iterative server-side regeneration produces technical effects including improved processing speed, improved accuracy in aligning generated images with user intent, reduced communication overhead, and more efficient utilization of computing resources.

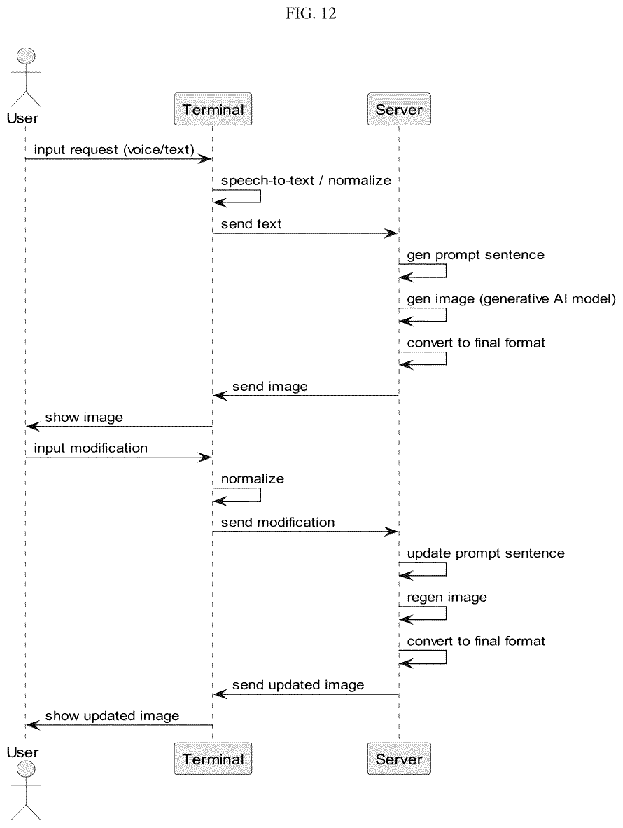

The following describes the processing flow using FIG. 12.

### Step 1

The user operates the terminal to provide an initial design request in natural language.

The user speaks into a microphone of the terminal or types text into an input field displayed on the terminal.

Input: The user provides a natural language request (spoken audio or typed text), such as “Create a bright banner for a summer sale with 50% OFF text.”

Output: The terminal holds either raw audio data in a buffer or a raw text string in memory.

### Step 2

The terminal converts the natural language input into normalized text information.

When the input is audio, the terminal executes speech recognition software to transform the audio waveform into a sequence of characters. The terminal segments the audio signal into frames, extracts acoustic features, applies an acoustic model and a language model, and outputs recognized text.

When the input is typed, the terminal collects keystroke events and assembles them into a string.

The terminal then normalizes the text by applying character encoding conversion, removal of invalid control characters, and optional simple corrections.

Input: Raw audio data or raw text string.

Output: Normalized text information representing the user's request.

### Step 3

The terminal packages the normalized text and sends it to the server.

The terminal constructs a request object containing fields such as user identifier, language identifier, and the normalized text. The terminal serializes this object into a structured format and transmits it to the server through the network interface using a secure protocol.

Input: Normalized text information and associated user metadata.

Output: A network message containing the normalized text request sent to the server.

### Step 4

The server receives the request and parses the text information.

The server accepts the network message via a communication module, verifies the message integrity, and extracts the normalized text. The server stores the extracted text and metadata in working memory and may assign a request identifier.

Input: Network message from the terminal containing the normalized text request.

Output: Internal data structures on the server containing the normalized text and associated identifiers.

### Step 5

The server generates a first-stage representation for prompt generation.

The server tokenizes the normalized text into a sequence of tokens using a tokenizer and converts each token into a numerical embedding by table lookup in an embedding matrix.

The server thereby transforms character-level data into a numerical vector sequence suitable for processing by a generative language model.

Input: Normalized text information representing the user's request.

Output: A sequence of numerical token embeddings stored in memory.

### Step 6

The server generates a prompt sentence using a generative AI model configured as a language model.

The server feeds the token embeddings into a transformer-based generative language model.

The server performs attention computations, matrix multiplications, and non-linear activations across multiple layers to compute output token probabilities. The server then selects output tokens according to the probabilities and forms a prompt sentence that describes the desired visual content in a structured and detailed manner.

For example, the server generates a prompt sentence such as:

“A bright, colorful web banner for a summer sale, using warm yellow and orange tones, with large bold text ‘50% OFF’ centered in the layout, a clean modern design, and space for a company logo in the top right corner.”

Input: Sequence of numerical token embeddings derived from the user's request.

Output: A textual prompt sentence that is structured for use by a generative image model.

### Step 7

The server normalizes and augments the prompt sentence for image generation.

The server analyzes the generated prompt sentence to detect missing attributes such as aspect ratio or resolution. The server may append standard terms such as “high resolution”, “16:9 aspect ratio”, or “for web banner use”. The server may also enforce a canonical order of description segments, such as background, foreground, text content, and style, to improve model consistency.

Input: Generated prompt sentence from the generative language model.

Output: A normalized and possibly augmented prompt sentence optimized for controlling the generative image model.

### Step 8

The server converts the prompt sentence into an embedding suitable for a generative image model.

The server applies a text encoder associated with the generative image model. The server tokenizes the prompt sentence again according to the image model's tokenizer, performs embedding lookup, and processes the embeddings through the text encoder network (for example, a transformer encoder). The server obtains a text embedding vector or a sequence of vectors that represent the semantic content of the prompt sentence.

Input: Normalized and augmented prompt sentence.

Output: Text embedding data for conditioning the generative image model.

### Step 9

The server generates visual representation data with a generative AI model configured as an image model.

The server initializes a latent image representation, for example as random noise in a multidimensional latent space. The server then runs an iterative denoising or sampling process. At each iteration, the server inputs the current latent representation and the text embedding into a denoising network, computes a predicted noise or update, and modifies the latent representation accordingly. After a fixed number of iterations or until a convergence criterion is met, the server decodes the latent representation into a pixel-space image using a decoder network.

Input: Text embedding derived from the prompt sentence and an initial latent noise representation.

Output: Visual representation data in the form of a multidimensional array of pixel values.

### Step 10

The server converts the visual representation data into visual material data in commercially usable format.

The server invokes image processing software to perform format conversion, resizing, and metadata embedding. The server reads the pixel array, encodes it into an image file format such as PNG or JPEG, adjusts resolution to predetermined sizes, and writes metadata such as color profile and usage information into the file header. The server may also optimize file size using compression parameters.

Input: Visual representation data generated by the generative image model.

Output: Visual material data in one or more commercially usable file formats.

### Step 11

The server stores and transmits the visual material data to the terminal.

The server assigns identifiers to the generated visual material data, stores it in non-volatile storage, and associates it with the original request and prompt sentence. The server then creates a response message including references or the file data itself and transmits this message to the terminal over the network.

Input: Visual material data and associated identifiers.

Output: A response message containing visual material data or access information sent to the terminal.

### Step 12

The terminal receives, stores, and displays the visual material data to the user.

The terminal accepts the response message, parses the contained data, and stores the image files or access links in local memory. The terminal uses a rendering engine to decode the image file and draw it on the display. The terminal may also display the prompt sentence as a caption or description.

Input: Response message from the server containing visual material data.

Output: A rendered visual output on the terminal's display that is viewable by the user.

### Step 13

The user reviews the displayed visual material and decides whether to request modifications.

The user examines the image on the terminal's display and evaluates whether colors, layout, and text placement meet the intended requirements. Based on this evaluation, the user either accepts the result or formulates a modification request in natural language, such as “Change the background to blue and move the ‘50% OFF’ text to the center.”

Input: Displayed visual material data and related description.

Output: A decision by the user and, if needed, a new natural language modification request.

### Step 14

The terminal acquires and normalizes the modification request.

The terminal captures the modification request via voice input or text input, as in the initial request. The terminal converts any audio into character data using speech recognition and normalizes the resulting text. The terminal constructs a modification data structure that includes the request identifier and the normalized modification text.

Input: User's natural language modification request (audio or text).

Output: Normalized modification text associated with the identifier of the prior visual material.

### Step 15

The server receives the modification text and retrieves related context.

The server obtains the modification data structure from the terminal and uses the identifier to access stored records including the original user request, the previous prompt sentence, and references to the previous visual material data. The server prepares a combined text input that includes both the original request and the modification request.

Input: Normalized modification text and identifier from the terminal; stored records for the original generation.

Output: A combined textual description representing both the initial intent and the requested changes.

### Step 16

The server generates an updated prompt sentence based on the combined description.

The server converts the combined description into token embeddings and feeds them into the generative language model. The server computes new output token probabilities and constructs a revised prompt sentence that incorporates the requested changes while preserving relevant parts of the original specification. For example, the server generates: “A bright web banner for a summer sale with a vivid blue background, large bold text ‘50% OFF’ centered in the middle, and accent colors in light yellow for contrast.”

Input: Combined textual description including the original request and the modification request.

Output: Updated prompt sentence that encodes the requested modifications.

### Step 17

The server regenerates visual representation data using the updated prompt sentence.

The server encodes the updated prompt sentence into a new text embedding and optionally initializes the latent representation using the previous image's latent or pixel representation.

The server performs iterative denoising or sampling again, but may reduce the number of iterations due to reuse of prior information. The server decodes the new latent representation to obtain updated visual representation data that reflects the modification.

Input: Updated prompt sentence and, optionally, prior latent or image data.

Output: Updated visual representation data with modified attributes.

### Step 18

The server reconverts and retransmits updated visual material data to the terminal.

The server repeats the image processing steps to obtain updated visual material data in commercially usable format. The server stores new records linked to the same identifier and transmits the updated data to the terminal.

Input: Updated visual representation data.

Output: Updated visual material data sent to the terminal for display to the user.

### Step 19

The terminal updates the display and the user decides whether to perform further iterations.

The terminal receives the updated visual material data, renders it on the display, and optionally shows the updated prompt sentence. The user observes the new image, and if further changes are desired, the user issues additional modification requests. The terminal and server then repeat Steps 14 through 18 as needed.

Input: Updated visual material data from the server.

Output: Updated display on the terminal and, if necessary, additional modification requests from the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented image generation systems that use generative AI models generally operate as thin wrappers around underlying models. Such systems typically accept a free-form prompt sentence from a user and directly forward the prompt sentence to a generative AI model, returning a raw output image without substantial intermediate processing. As a result, these systems suffer from several technical limitations at the computing-system level.

First, conventional systems do not adequately analyze or structure the natural-language input, and therefore cannot reliably extract machine-interpretable parameters such as object information, background information, style information, resolution requirements, and use-case requirements. Because these systems lack processor-level mechanisms to decompose and normalize a prompt sentence into structured generation conditions, the mapping from user intent to model input is unstable and highly dependent on manual prompt engineering by the user. This leads to inconsistent utilization of computational resources, repeated failed generations, and unnecessary re-execution of expensive model inference operations on a processing device such as a graphics processing unit.

Second, conventional systems typically do not perform adaptive model selection or configuration based on structured use-case information. A single generative AI model configuration is often used for all requests, regardless of whether the request is for a logo, an illustration, or a high-resolution poster. This lack of dynamic selection and configuration at the processor level results in suboptimal use of available models and hardware accelerators. For example, a model tuned for photo-realistic scenes may be inefficiently used for flat-design logos, causing prolonged processing time, increased memory consumption, and degraded throughput of the overall computing system.

Third, conventional systems frequently output images in raw or generic formats without systematic post-processing. They do not integrate, at the processor and memory level, coordinated image processing functions such as resolution conversion, image quality correction, encoding format conversion, and color space conversion that are tailored to business-grade usage conditions. Consequently, users must perform separate manual conversions using external tools. This introduces additional data transfers, repeated encoding/decoding operations, and fragmented processing pipelines, all of which increase latency, reduce throughput, and complicate storage and caching strategies in server-side systems.

Fourth, conventional systems do not provide an integrated feedback loop in which modification requests from a terminal are incorporated into a structured prompt regeneration process in the server. In many cases, when a user modifies a prompt sentence, the system simply restarts the entire workflow from scratch without reusing prior structured information or generation conditions. This leads to redundant computations, increased network traffic between the server and the terminal, and inefficient usage of memory and compute resources on the server.

In view of the foregoing, there is a need for a computer-implemented system in which a processor is configured to (i) systematically analyze and structure natural-language requests into machine-interpretable prompt sentences and generation conditions, (ii) dynamically select and configure one or more generative information processing models based on extracted use-case information, (iii) execute image generation and integrated post-processing in a coordinated pipeline to output visual content data directly in a format suitable for business use, and (iv) incorporate iterative modification requests into a controlled regeneration process. By implementing these functions at the processor level, the computing system can improve the technical operation of generative AI-based image generation, including reduction of unnecessary inference runs, more efficient use of specialized hardware resources, more predictable memory and storage usage, and reduced end-to-end latency for generating commercially usable visual content data.

The specific processing by the specific processing unit 290 of the data processing device 12 in Example 2 is realized by the following means.

The present invention provides a server comprising a processor that is configured to receive, from a terminal operated by a user, a request expressed in natural language; analyze the request expressed in natural language by language processing to extract information indicating at least an object, a background, a style, a resolution, and a use case, and generate a structured prompt sentence for generation on the basis of the extracted information; select a generative information processing model as a generative AI model on the basis of the structured prompt sentence and image generation conditions, configure the generative information processing model, and transmit the structured prompt sentence to the generative information processing model to cause the generative information processing model to generate pixel information of visual content by numerical computation; perform image processing on the generated pixel information, the image processing including at least resolution conversion, image quality correction, encoding format conversion, and color space conversion, to convert the generated pixel information into visual content data in a format suitable for business use; transmit the converted visual content data to the terminal as information that is visually displayable on the terminal; and regenerate the structured prompt sentence on the basis of a modification request re-input from the terminal and repeatedly execute processing for generating the visual content data. This enables a computing system to technically improve the operation of generative AI-based image generation by transforming unstructured natural-language input into structured, model-ready conditions, by dynamically selecting and configuring generative information processing models according to use-case information, by integrating post-processing into a unified pipeline that outputs business-grade visual content data without separate external tools, and by reducing redundant computations through an iterative regeneration mechanism that reuses structured information in response to modification requests, thereby enhancing processing efficiency, resource utilization, and responsiveness of the server.

The term “terminal” refers to an information processing apparatus operated by a user, including but not limited to a mobile device, a personal computer, or any other user interface device capable of transmitting a request and receiving visual content data via a communication network.

The term “user” refers to a human operator or entity that interacts with the terminal to input a request expressed in natural language and to view or utilize visual content data generated by the system.

The term “request expressed in natural language” refers to an instruction or description provided by the user using a human language, such as a sentence or phrase, that specifies desired characteristics or conditions of visual content to be generated.

The term “language processing” refers to a computational procedure that analyzes the request expressed in natural language to identify and extract structured information, including objects, backgrounds, styles, resolutions, use cases, and other semantic elements relevant to visual content generation.

The term “object information” refers to information indicating one or more primary entities, subjects, or elements that are to be visually represented in the visual content.

The term “background information” refers to information indicating a surrounding scene, environment, or context in which the object or objects are to be visually arranged within the visual content.

The term “style information” refers to information indicating an artistic, graphical, or visual manner of representation for the visual content, including but not limited to illustration style, photographic style, abstraction level, or design approach.

The term “resolution information” refers to information indicating pixel dimensions, level of detail, or output size requirements for the visual content to be generated.

The term “use case information” refers to information indicating an intended usage scenario for the visual content, including but not limited to business use, branding use, printing use, web use, or interface use, and serving as a basis for model selection and post-processing.

The term “structured prompt sentence” refers to a reformulated and organized representation of the request expressed in natural language, generated on the basis of extracted information and configured to serve as a suitable input for a generative information processing model.

The term “image generation conditions” refers to a set of parameters associated with generating visual content, including but not limited to image size, aspect ratio, number of generation steps, sampling strategy, quality level, and randomness control parameters.

The term “generative information processing model” refers to a computational model, including but not limited to a machine learning model or neural network, that generates visual content data on the basis of input information such as a structured prompt sentence and image generation conditions.

The term “generative AI model” refers to a type of generative information processing model that utilizes artificial intelligence techniques, such as deep learning or probabilistic modeling, to perform automatic generation of data including visual content.

The term “numerical computation” refers to processing in which the generative information processing model performs arithmetic or algebraic operations on numerical data, including vector, matrix, or tensor data, to produce pixel information representing visual content.

The term “pixel information” refers to data representing values of picture elements in a two-dimensional or multi-dimensional grid, including but not limited to color values, brightness values, or transparency values that define a digital image.

The term “visual content” refers to any computer-generated or computer-processed image, graphic, illustration, or other visual representation produced by the system.

The term “visual content data” refers to digital data representing visual content in a storable and transmittable form, including but not limited to files encoded in raster image formats.

The term “image processing” refers to a sequence of computational operations performed on pixel information or visual content data, including at least resolution conversion, image quality correction, encoding format conversion, and color space conversion.

The term “resolution conversion” refers to a processing operation that changes the number of pixels or pixel arrangement of visual content, including down-sampling, up-sampling, or rescaling procedures.

The term “image quality correction” refers to a processing operation that improves or adjusts visual characteristics of the visual content, including but not limited to sharpening, noise reduction, contrast adjustment, and detail enhancement.

The term “encoding format conversion” refers to a processing operation that converts visual content data from one data encoding scheme or file format to another, such as conversion between different raster image formats or compression schemes.

The term “color space conversion” refers to a processing operation that converts color values of visual content data from one color representation system to another, such as conversion between different device-dependent or device-independent color spaces.

The term “business use” refers to an intended use of visual content in a commercial or professional context, including but not limited to advertising, branding, publication, product packaging, or internal business documentation.

The term “format suitable for business use” refers to a state of visual content data in which resolution, encoding, color characteristics, and quality characteristics satisfy predetermined conditions for the intended business use, including compatibility with business workflows and output devices.

The term “modification request” refers to a request re-input from the terminal that changes, refines, or supplements a previous request expressed in natural language, and that is used as a basis to regenerate the structured prompt sentence.

The term “regenerate the structured prompt sentence” refers to a processing operation that produces a new or updated structured prompt sentence by taking into account a modification request while optionally reusing at least part of previously extracted information or image generation conditions.

The term “processing for generating the visual content data” refers to a series of operations including at least selection and configuration of a generative information processing model, numerical computation for generating pixel information, and image processing that converts the pixel information into visual content data.

The term “image generation information processing model” refers to a generative information processing model specialized for generating images or other visual content on the basis of input conditions.

The term “plurality of types of image generation information processing models” refers to two or more image generation information processing models that differ in at least one aspect, such as architecture, training data, output characteristics, or optimization for particular use cases.

The term “select at least one image generation information processing model” refers to a processing operation in which the processor chooses one or more image generation information processing models from the plurality of types in response to use case information or other conditions.

The term “screen composition” refers to a spatial arrangement of objects, backgrounds, and other visual elements within a frame of the visual content, including relative positions, sizes, and layout balance.

The term “color scheme” refers to a combination or selection of colors used in the visual content, including overall tone, palette structure, and color balance.

The term “background information of the visual content data” refers to data that defines background elements and regions in the visual content, including scenes, gradients, textures, or patterns that lie behind primary objects.

The term “information creation task” refers to a task in which a user prepares or edits informational materials, including but not limited to documents, presentations, marketing materials, or instructional content.

The term “design task” refers to a task in which a user creates or refines visual layouts, branding assets, user interfaces, product designs, or other design artifacts that incorporate visual content.

The term “optimize the visual content data” refers to a processing operation that adjusts or refines the visual content data so as to satisfy one or more performance or quality criteria, such as suitability for a particular output channel, consistency with a design guideline, or improvement of usability in a workflow.

In one embodiment, a server, a terminal, and a user cooperate to implement the claimed system. The server is implemented as a computer system including at least one central processing unit (CPU), at least one graphics processing unit (GPU), a main memory, a non-volatile storage device such as a solid-state drive, and a network interface. The server executes system software such as an operating system and application software including a language processing module, a generative AI model execution module, and an image post-processing module. The terminal is implemented as a client device such as a smartphone, a tablet computer, or a personal computer, and the terminal executes an application or a web browser that communicates with the server via a communication network such as the Internet. The user operates the terminal to input a prompt sentence and to review generated visual content.

The server maintains a language processing module that runs on the CPU, optionally accelerated by the GPU, and that includes a tokenizer, a part-of-speech tagger, an entity recognizer, and a semantic parser. The server uses this language processing module to analyze a prompt sentence expressed in natural language. The server represents the prompt sentence as a sequence of tokens, and the server maps the tokens to numerical indices stored in an embedding table. The server then computes embedding vectors for the tokens and applies a sequence model such as a transformer-based neural network or a recurrent neural network to derive contextualized representations. The server thereby extracts structured information, including object information, background information, style information, resolution information, and use case information.

The server, for example, receives a prompt sentence such as “A landscape with silhouetted trees and a deer against a sunset background, suitable for a commercial poster.” The server identifies “landscape,” “trees,” and “deer” as object information, identifies “sunset background” as background information, identifies “commercial poster” as use case information, and interprets “suitable for a commercial poster” as implying a high-resolution requirement. The server normalizes these elements into a structured representation, such as an internal data structure that associates each semantic element with attribute types (object, background, style, resolution, use case) and that encodes them as numerical feature vectors.

The server generates a structured prompt sentence on the basis of the extracted information. The server concatenates text fragments according to predefined templates that are stored in memory and that are selected based on the use case information. The server, in this example, generates a structured prompt sentence such as “High-resolution illustration of a landscape with silhouetted trees and a deer in front of a vivid sunset sky, poster quality.” The server also constructs associated image generation conditions, such as output width and height in pixels, sampling steps, and guidance scale values. The server records these conditions in a parameter data structure that is stored in the main memory.

The server selects a generative information processing model as a generative AI model from a plurality of image generation models on the basis of the use case information and the structured prompt sentence. The server may maintain multiple models in storage, such as a diffusion-based model, a generative adversarial network-based model, or a transformer-decoder-based image generator. The server loads one or more models into GPU memory as needed. For high-resolution posters, the server may select a diffusion-based model, whereas for flat logos, the server may select a vector-oriented or low-detail model. The server performs a model selection algorithm that evaluates the use case information, such as “poster,” “logo,” or “web banner,” and chooses a model configuration with preset resolution ranges, memory allocation limits, and inference parameters.

The server, for example, selects a diffusion-based generative AI model for a prompt sentence such as “A landscape with silhouetted trees and a deer against a sunset background, suitable for a commercial poster.” The server configures the diffusion model with an image size of 4096×4096 pixels, a specified number of denoising steps, and a guidance scale chosen to balance fidelity to the prompt sentence and diversity of outputs. The server copies the structured prompt sentence and the parameter data structure into GPU-accessible memory.

The server executes the generative AI model on the GPU to generate pixel information for the visual content. The server encodes the structured prompt sentence using a text encoder network of the model, such as a transformer encoder or another neural network configured to map token sequences to fixed-length embedding vectors. The server stores the text embedding vectors in GPU memory. The server then initializes latent image tensors with random noise according to a specified distribution, and the server iteratively applies a denoising network such as a U-Net architecture. In each denoising iteration, the server feeds the current latent tensor and the text embedding to the denoising network, and the server obtains an updated latent tensor. The server computes gradients internally during training, but in inference mode the server performs forward passes only, which involve matrix multiplications, convolutions, activation functions, and normalization layers that are executed on the GPU.

The server decodes the final latent tensor using a decoder network, such as a variational autoencoder decoder, to obtain an RGB array representing pixel information. The server thus outputs a multidimensional tensor in memory where each element stores color values for a pixel location. The server may generate multiple candidate images by repeating the denoising process with different random seeds while keeping the text embedding fixed. The server stores the pixel information for each candidate in GPU or main memory.

The server performs image processing on the pixel information to convert it into visual content data suitable for business use. The server uses an image processing library such as a software component for image manipulation running on the CPU and optionally designated GPU kernels for specific operations. The server performs resolution conversion by resampling the pixel grid using algorithms such as bicubic interpolation or, in some embodiments, a specialized super-resolution neural network that upsamples the image while preserving edges and textures. The server performs image quality correction such as contrast enhancement, noise reduction, or sharpening by applying convolution filters and non-linear operations on the pixel array. The server performs encoding format conversion by transforming the raw RGB array into a compressed file format such as a lossless raster format or a compressed raster format, and the server chooses compression parameters according to the use case information. The server performs color space conversion by transforming color values from an internal representation to a standardized color space such as sRGB, which ensures consistent reproduction on display devices and in print workflows.

The server generates visual content data as files that contain encoded pixel information along with metadata indicating resolution, color space, and other technical attributes. The server stores the visual content data in non-volatile storage and associates it with identifiers. The server then transmits the visual content data, or references to the data, to the terminal via the network interface. The server encapsulates the data in a response message and adds headers indicating content type and length to optimize buffer allocation and transmission at the terminal.

The terminal receives the visual content data, decodes it using a media subsystem of the operating system, and renders the image on the display. The terminal may use a graphics subsystem to scale and composite the image. The user views the image and determines whether it satisfies the intent conveyed in the prompt sentence. The user may input a modification request such as “Make the colors more vivid and move the deer closer to the center.” The terminal sends the modification request to the server as a new natural-language message that references the prior generation.

The server receives the modification request and updates the structured representation. The server does not simply discard the previous analysis; instead, the server reuses prior object information, background information, and use case information, and the server updates only the elements that are affected by the modification request. The server, for example, adjusts the color scheme attributes and the object position attributes in the structured representation. The server then regenerates a structured prompt sentence such as “High-resolution illustration of a landscape with silhouetted trees and a deer closer to the center in front of a more vivid sunset sky, poster quality.” The server thereby reduces redundant language analysis and model selection computations compared to re-processing an entirely new prompt without context.

The server again executes the generative AI model with the updated structured prompt sentence and potentially reuses parts of the computational graph or cached text embeddings. By reusing the text embedding for unchanged components of the prompt sentence and recalculating only the modified parts, the server reduces GPU computation time. The server then repeats the image processing pipeline and transmits updated visual content data to the terminal. This iterative regeneration, based on structured representation reuse, improves processing efficiency and reduces latency, particularly in environments where the server processes large numbers of user requests.

The server in some embodiments further manages multiple generative AI models of different architectures. The server may maintain a diffusion-based model for photographic and illustrative images, a vector approximation model for logo-like graphics, and an adversarial network-based model for textures. The server holds configuration rules that map use case information and style information to model selections. For example, when the user enters a prompt sentence such as “A minimalist flat-design logo of a deer and trees in silhouette, white background, suitable for commercial branding materials,” the server determines that the use case corresponds to logo generation. The server then selects an image generation model with constraints on color palette size, background uniformity, and edge simplicity. The server configures this model with a resolution appropriate for logo assets and with parameters that emphasize clear boundaries and low texture complexity. The server thereby increases the quality of the output for that specific use case and reduces unnecessary computation that would occur if a more complex, texture-oriented model were used.

The server trains the generative AI models in advance using a dataset of image and text pairs. The server during training encodes the text portion into embeddings and passes the image portion through an encoder to obtain latent representations. The server computes a loss function such as a reconstruction loss for pixels, a perceptual loss over feature activations, or a noise prediction loss for diffusion models. The server updates model weights using an optimization algorithm such as stochastic gradient descent or a variant, and the server may employ techniques such as learning rate scheduling, gradient clipping, and batch normalization. During training, the server applies data augmentation operations on images, such as random cropping, rotation, and color jitter, to improve model generalization. The server thus configures the generative AI models so that, at inference time, the models can efficiently transform structured prompt sentences and generation conditions into pixel information with predictable quality and computational characteristics.

The server implements data structures for internal data flows that are specifically arranged to improve computational efficiency. The server represents each request with a record that contains fields for the original prompt sentence, tokenized form, structured representation, model selection flags, generation parameters, intermediate pixel information identifiers, and final visual content data identifiers. The server stores these records in a memory-resident queue that supports priority scheduling. The server can thereby batch multiple model inference calls together, especially when multiple requests select the same generative AI model and similar resolution requirements. The server uses this batching mechanism to group text embeddings and latent tensors into larger tensors, which the GPU processes more efficiently due to parallelism. This particular arrangement of data structures and batching operations improves throughput and reduces average processing time per image compared to processing each request individually.

The server in some embodiments performs additional internal checks on generated pixel information. The server may compute histogram statistics of pixel values to detect abnormally dark or bright images or may compute simple feature descriptors to approximate content coverage. When the server detects that an output does not meet pre-defined technical thresholds, such as minimum variance or edge density, the server may automatically regenerate an image with adjusted model parameters without requiring a new user interaction. This process reduces the number of unusable outputs sent to the terminal and saves network bandwidth.

The server thereby improves computer technology in several respects. By structuring the prompt sentence and extracting explicit attributes, the server converts ambiguous natural-language text into a deterministic set of parameters that can be processed efficiently and repeatedly. This reduces accidental model misuse, lowers the number of failed generations, and improves hardware utilization. By dynamically selecting an appropriate generative AI model and parameter set based on use case information, the server matches computational complexity to task requirements and avoids unnecessary memory consumption and processing time. By integrating resolution conversion, quality correction, encoding format conversion, and color space conversion in an automated pipeline, the server eliminates intermediate manual conversions and reduces the number of encode/decode cycles. This in turn reduces cumulative quantization errors and processing overhead. By reusing structured representations and embeddings when handling modification requests, the server decreases redundant calculations, leading to lower latency and reduced load on processing units.

The terminal and the user together enable real-world use of the generated visual content. The terminal receives and displays the visual content data in real time, enabling the user to review and incorporate the images into downstream workflows such as printing, digital publishing, or application interface deployment. The server may directly adjust output to fit specific device profiles, such as particular display color gamuts or printer color characteristics, by applying device-specific color space conversions and resolution adjustments. The server thereby controls a chain of technical components, from text input handling, through specialized model execution on GPUs, to specific encoding and delivery of image files that are immediately suitable for use on external devices and in physical media.

Alternative embodiments can vary the architecture while maintaining the same essential technical operations. The server may use a different neural network architecture for language processing, such as a bidirectional encoder, or a different image generation backbone, such as a convolutional transformer. The server may employ different loss functions and training protocols, such as adversarial losses, perceptual similarity metrics, or noise-conditional objectives. The server may store the structured representation in different data structures, such as graph-based models or hierarchical attribute trees, and may apply rule-based refinement algorithms that adjust the structured prompt sentence according to pre-defined constraints. In all cases, the server continues to receive natural-language requests from the terminal, extract and structure semantic information, select and configure a generative AI model, generate pixel information by numerical computation, post-process the pixel information into business-grade visual content data, and support iterative refinement based on modification requests, thereby achieving the technical effects described above.

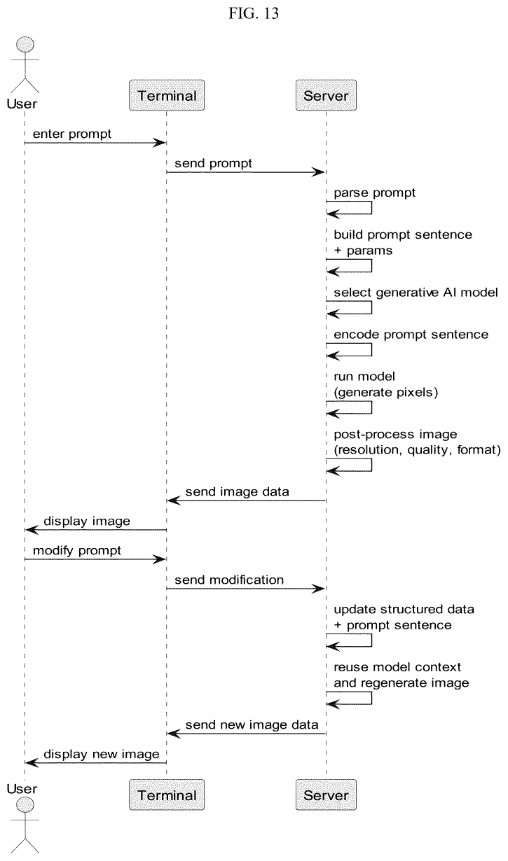

The following describes the processing flow using FIG. 13.

### Step 1

The user operates the terminal and inputs a prompt sentence in natural language into an input field provided by an application or a web page.

The terminal receives, as input, character data representing the prompt sentence and optional user settings such as desired resolution or style.

The terminal converts the character data into an internal text string, validates that the string is not empty, and attaches metadata such as a user identifier and a timestamp.

The terminal outputs a structured request message that contains the prompt sentence and the metadata.

### Step 2

The terminal transmits the structured request message to the server via a network using a communication protocol such as HTTP over TLS.

The terminal receives, as input, the internal text string and metadata from Step 1.

The terminal serializes the request message into a transmission format such as a JSON object in the body of an HTTP POST request, and resolves the destination address of the server.

The terminal outputs a network packet stream that encapsulates the serialized request message and sends it to the server.

### Step 3

The server receives the network packet stream and reconstructs the structured request message.

The server receives, as input, the incoming network packets and decodes the communication protocol headers and body to obtain the serialized request.

The server parses the serialized data structure to extract the prompt sentence, user identifier, and associated settings, and performs validation checks such as confirming the presence of the prompt sentence and verifying that its length is within allowed limits.

The server outputs a validated request object stored in main memory, containing the prompt sentence and associated metadata.

### Step 4

The server performs language processing on the prompt sentence to extract structured attributes.

The server receives, as input, the prompt sentence from the validated request object.

The server applies a tokenizer to divide the prompt sentence into tokens, maps the tokens to numerical indices using an embedding table, and passes the indices through a sequence model such as a transformer encoder to compute contextual embedding vectors.

The server applies additional analysis modules, such as part-of-speech tagging and entity recognition, to identify object information, background information, style information, resolution information, and use case information.

The server outputs a structured representation object that includes, in a machine-interpretable form, attribute fields and numerical feature vectors corresponding to the extracted information.

### Step 5

The server generates a structured prompt sentence and image generation conditions based on the structured representation.

The server receives, as input, the structured representation object from Step 4.

The server selects a template corresponding to the extracted use case information and concatenates normalized text fragments representing objects, backgrounds, styles, and quality requirements to form a structured prompt sentence.

The server computes image generation conditions such as target width and height in pixels, number of inference steps, and guidance scale, using rule-based logic that maps use case and resolution information to numeric parameter values.

The server outputs a generation configuration object that contains the structured prompt sentence and the associated image generation conditions.

### Step 6

The server selects and configures a generative AI model on the basis of the generation configuration object.

The server receives, as input, the structured prompt sentence, the image generation conditions, and the use case information.

The server evaluates model selection rules that map use cases (for example, logo, poster, illustration) to available model types (for example, diffusion-based, adversarial-network-based, or vector-oriented models) and chooses at least one generative AI model.

The server loads model parameters from non-volatile storage into main memory and GPU memory if not already loaded, allocates GPU resources according to the resolution and batch size, and sets internal model parameters such as sampling schedule and noise level sequence in accordance with the image generation conditions.

The server outputs a prepared model context that associates the selected generative AI model with the structured prompt sentence and the generation parameters.

### Step 7

The server encodes the structured prompt sentence into numerical embeddings used by the generative AI model.

The server receives, as input, the structured prompt sentence from the prepared model context.

The server tokenizes the structured prompt sentence according to the vocabulary of the model's text encoder, maps tokens to embedding vectors, and processes the sequence through the text encoder network to produce one or more fixed-length embedding vectors representing the semantic content of the prompt.

The server stores these embedding vectors in GPU memory for subsequent use in the image generation process.

The server outputs a text embedding tensor that numerically represents the structured prompt sentence.

### Step 8

The server initializes latent image data and performs iterative numerical computation to generate pixel information using the generative AI model.

The server receives, as input, the text embedding tensor and the image generation conditions.

The server generates an initial latent tensor by sampling random noise from a predefined distribution according to the target resolution and model architecture.

The server iteratively applies the core network of the generative AI model, such as a U-Net in a diffusion model, where each iteration takes as input the current latent tensor, the text embedding tensor, and a time or step index, and outputs an updated latent tensor with reduced noise and increased structure that reflects the prompt content.

The server repeats these iterations for the number of steps specified in the image generation conditions, thereby performing a sequence of matrix multiplications, convolutions, non-linear activations, and normalization operations on the GPU.

The server outputs a final latent tensor that encodes the content of the desired visual image in a latent space.

### Step 9

The server decodes the final latent tensor into a raw pixel array representing the visual content.

The server receives, as input, the final latent tensor from Step 8.

The server passes the latent tensor through a decoder network, such as a variational autoencoder decoder, which applies learned deconvolution layers and activation functions to transform latent features into spatially arranged color information.

The server converts internal numeric representations into an RGB array where each element corresponds to a pixel with channel values, and normalizes these channel values into a fixed numeric range suitable for display or further processing.

The server outputs a raw pixel array that constitutes uncompressed pixel information for the generated image.

### Step 10

The server performs resolution conversion and image quality correction on the raw pixel array.

The server receives, as input, the raw pixel array and the target resolution and quality parameters from the image generation conditions.

The server calculates a scaling factor based on the current resolution and the target resolution, and applies an interpolation algorithm such as bicubic interpolation or invokes a super-resolution neural network to resample the image to the target size.

The server applies image quality correction filters such as noise reduction, edge sharpening, and contrast adjustment by convolving the pixel array with pre-defined kernels and applying non-linear transformations.

The server outputs a refined pixel array that has the target resolution and improved visual quality.

### Step 11

The server performs encoding format conversion and color space conversion to generate visual content data suitable for business use.

The server receives, as input, the refined pixel array and information about the desired output format and color space derived from the use case information.

The server converts the pixel array from an internal color representation to a standardized color space such as sRGB by applying a color transform matrix or a look-up table.

The server then encodes the pixel data into a file format such as a compressed raster format or a lossless raster format by applying a compression algorithm with parameters selected according to use case constraints, such as quality level and file size limits.

The server embeds metadata fields such as resolution, color profile, and usage flags into the file header if supported by the format.

The server outputs visual content data as a binary file or byte stream that is directly storable and transmittable.

### Step 12

The server prepares and transmits a response containing the visual content data to the terminal.

The server receives, as input, the visual content data and the user identifier or session identifier from the validated request object.

The server assigns a storage identifier or URL to the visual content data by saving it to a storage subsystem and recording its location in an index.

The server constructs a response message that includes either the visual content data itself or a reference to the stored data, and attaches technical attributes such as file format and resolution as part of the response body or headers.

The server outputs a network packet stream containing the response message and sends it to the terminal.

### Step 13

The terminal receives the response and renders the visual content for the user.

The terminal receives, as input, the network packet stream from the server.

The terminal decodes the communication protocol headers and extracts the response body, then retrieves the visual content data directly or requests it from the provided URL.

The terminal passes the received visual content data to a media subsystem that decodes the encoded image into a pixel buffer and renders the image on a display surface, scaling it as necessary to match the terminal's screen dimensions.

The terminal outputs a displayed image that the user can visually inspect.

### Step 14

The user evaluates the displayed image and optionally inputs a modification request.

The user receives, as input, the displayed image on the terminal's screen.

The user compares the image to the intended concept and, when necessary, formulates a refined prompt sentence or modification request such as “Increase the vividness of the sunset and move the deer to the center.”

The user enters the modification request through an input interface on the terminal.

The terminal outputs a new structured request message that includes the modification request and context identifying the previous generation.

### Step 15

The server processes the modification request by updating the structured representation and repeating generation with partial reuse.

The server receives, as input, the new structured request message containing the modification request and context information.

The server reuses the existing structured representation from the prior request, identifies portions affected by the modification (for example, color intensity and object position), and updates only the corresponding fields and feature vectors using targeted language processing on the modification text.

The server regenerates a structured prompt sentence and updates image generation conditions, then re-enters the model selection, encoding, generation, and post-processing flow using cached embeddings or parameters where possible.

The server outputs new visual content data that reflects the modification request with reduced redundant computation compared to a full reprocessing from scratch.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that use machine learning models typically accept a single free-form text input and directly pass that text to a generative model. Such systems suffer from several technical deficiencies in terms of computer technology itself. First, the raw natural language request often contains ambiguous or incomplete information regarding visual attributes such as object types, color characteristics, composition, intended usage, and emotional nuance, which leads to low relevance outputs and requires repeated trial-and-error prompts. This results in unnecessary repetitions of expensive model inference on computing resources such as processors and accelerators, thereby increasing processing time and network traffic within distributed computing environments.

Second, known systems generally do not integrate multi-modal user emotion information, such as voice characteristics or facial expressions, into the generation pipeline in a structured manner at the processor level. As a result, the generative model cannot adapt its internal generation parameters, such as style or color tone, to the current emotional state of the user. This lack of emotion-aware conditioning forces users to issue multiple manual adjustments and additional prompts, which again increases processor cycles, memory usage, and communication overhead between user terminals and servers.

Third, many existing systems treat the generative model as a monolithic component and do not perform dynamic model selection or adaptive parameter control based on the parsed content of the user request and the estimated task type. A single generic model and static configuration are used for all cases, which is inefficient for server-side computing resources. Large models are unnecessarily invoked for simple tasks, while inappropriate resolutions and layouts are generated for specific downstream uses such as wallpapers, advertising images, explanatory graphics, or decorative graphics. This leads to increased computational load, suboptimal memory allocation, and redundant post-processing operations.

Fourth, existing systems often lack a structured server-side mechanism to convert raw model outputs into commercially usable formats that are automatically associated with identification information, usage condition information, and safety checks. As a result, storage systems must handle heterogeneous and unverified binary data, which complicates indexing, retrieval, and compliance checking. This also makes it difficult for user terminals to efficiently retrieve, rank, and apply the generated visual materials to various graphical layouts without incurring additional local computation and manual editing.

Therefore, there is a need for an improved computer-implemented system that: (i) programmatically analyzes natural language requests to extract structured attribute information; (ii) estimates and integrates multi-modal user emotion information into extended prompt sentences; (iii) dynamically selects among a plurality of generative AI models and controls parameters based on content and usage category; (iv) performs efficient server-side post-processing, safety checking, and storage with associated metadata; and (v) automatically provides layout-aware, emotion-adaptive visual materials to user terminals. Such a system should reduce overall computational waste, improve throughput of generative processing, enhance the relevance and usability of outputs, and thereby improve the functioning of computers and networks implementing generative AI services.

The specific processing by the specific processing unit 290 of the data processing device 12 in Application Example 2 is realized by the following means.

The present invention provides a server comprising a processor configured to receive, from a user terminal, a request expressed in a natural language, analyze the received request by using language processing technology to extract attribute information including at least a target object, a color attribute, a composition attribute, a usage attribute, and an emotion expression, generate, on the basis of the attribute information, a prompt sentence for generation processing, analyze emotion-related information including audio information and image information acquired from the user to estimate an emotional state of the user by using at least one of text analysis, audio analysis, and image analysis, integrate the attribute information and the emotional state, add style information and expression conditions corresponding to the emotional state to the prompt sentence for generation processing, and generate an extended prompt sentence suitable for a generative AI model, select, on the basis of the extended prompt sentence, a generative AI model from among a plurality of types of generative AI models according to content of the request and a usage category, cause the generative AI model to generate visual material data by inputting the extended prompt sentence and the style information to the generative AI model, perform post-processing on the visual material data output from the generative AI model, the post-processing including at least one of resolution conversion, angle-of-view adjustment, tone correction, format conversion, and safety determination, convert the visual material data into an image format usable for commercial transactions, store the converted visual material data in an information storage device in association with identification information and usage condition information, transmit response data including reference information for acquisition to the user terminal, receive, on the basis of the response data, an additional request expressed in a natural language from the user terminal, update the extended prompt sentence by using the additional request and a past request history, and regenerate the visual material data on the basis of the updated extended prompt sentence. This enables the server to transform ambiguous natural language and multi-modal emotion inputs into structured, emotion-conditioned extended prompt sentences, to allocate an appropriate generative AI model and parameter set per request, to generate and normalize visual material data into commercially usable formats with associated metadata and safety guarantees, and to iteratively refine outputs using reduced network exchanges and reduced redundant model executions, thereby improving processing efficiency, resource utilization, and practical usability of generative AI in computer-based content generation workflows.

The term “user terminal” refers to an information processing apparatus operated by a user, such as a computing device or communication device, that transmits a natural language request and receives generated visual material data from the server.

The term “request expressed in a natural language” refers to an instruction or demand described in a human language, in text or speech form, which specifies at least a desired content, appearance, or usage of visual material.

The term “language processing technology” refers to a software-implemented technique or algorithm, including natural language processing, that analyzes a natural language string to extract structured data such as tokens, parts of speech, entities, and semantic attributes.

The term “attribute information” refers to structured data elements extracted from a natural language request, including at least information about a target object, a color attribute, a composition attribute, a usage attribute, and an emotion expression.

The term “target object” refers to a conceptual or physical entity, such as a scene, item, or character, that is to be depicted or represented in the generated visual material.

The term “color attribute” refers to characteristic information regarding hues, saturation, brightness, or color schemes specified or implied in a natural language request.

The term “composition attribute” refers to information about spatial arrangement, layout, perspective, or relative positioning of elements to be included in the visual material.

The term “usage attribute” refers to information describing an intended use or context of the visual material, such as wallpaper, advertising image, explanatory graphic, or decorative graphic.

The term “emotion expression” refers to a word, phrase, or linguistic pattern contained in the natural language request that explicitly or implicitly indicates a desired emotional tone or mood.

The term “prompt sentence for generation processing” refers to a text sequence constructed by the processor that provides explicit, machine-oriented instructions to a generative AI model for generating visual material.

The term “emotion-related information” refers to data that can be used to infer a user's emotional state, including at least text data, audio information, and image information acquired from the user or the user terminal.

The term “audio information” refers to a digital signal representing the user's voice or other sound captured by an audio input component of the user terminal.

The term “image information” refers to digital image data, such as a still image or a sequence of frames, capturing at least a part of the user, including a facial region suitable for emotion analysis.

The term “emotional state” refers to an internal state of the user, such as happiness, sadness, surprise, calmness, or similar affective condition, estimated from emotion-related information.

The term “text analysis” refers to a computational process that examines textual data to detect patterns, sentiment, or emotional indicators.

The term “audio analysis” refers to a computational process that examines audio data to derive features such as pitch, tone, energy, or prosody to infer affective information.

The term “image analysis” refers to a computational process that examines image data to detect features such as facial expressions, shapes, or patterns to infer affective or contextual information.

The term “style information” refers to parameters describing a visual or artistic style, including but not limited to color tone, level of saturation, contrast, and overall mood, determined at least in part by the emotional state.

The term “expression conditions” refers to additional generation constraints or specifications, such as level of detail, realism, abstraction, or emphasis, that guide how the generative AI model renders the visual material.

The term “extended prompt sentence” refers to a prompt sentence that has been augmented with style information and expression conditions derived from the user's emotional state and attribute information, and that is configured to be suitable for input to a generative AI model.

The term “generative AI model” refers to a machine learning model, such as a neural network-based generative model, that generates new data, including visual material data, based on an input prompt sentence or latent representation.

The term “plurality of types of generative AI models” refers to multiple generative AI models having different architectures, training data, or specialization, from which one model is selected according to the request content and usage category.

The term “usage category” refers to a classification of intended use of generated visual material, such as wallpaper, advertising image, explanatory graphic, or decorative graphic, used to guide model selection and parameter configuration.

The term “visual material data” refers to digital data representing a visual output, such as an image or graphic, generated by a generative AI model.

The term “post-processing” refers to one or more computational operations applied to visual material data after generation, including at least resolution conversion, angle-of-view adjustment, tone correction, format conversion, or safety determination.

The term “resolution conversion” refers to a process of changing the pixel dimensions or density of visual material data to meet a specified resolution.

The term “angle-of-view adjustment” refers to a process of modifying cropping, perspective, or framing of visual material to achieve a desired view or composition.

The term “tone correction” refers to a process of adjusting brightness, contrast, color balance, or similar tonal parameters of visual material data.

The term “format conversion” refers to a process of changing the encoding format or file type of visual material data, such as conversion between different image formats.

The term “safety determination” refers to a process of evaluating visual material data for compliance with predetermined safety or policy criteria, such as absence of prohibited content or sensitive elements.

The term “image format usable for commercial transactions” refers to a standardized digital image format associated with usage conditions and technical parameters that allow the image to be used in commercial activities under defined policies.

The term “information storage device” refers to a storage apparatus or storage service, such as a memory device, storage system, or data repository, configured to store digital data including visual material data and metadata.

The term “identification information” refers to data used to uniquely associate stored visual material data with a user, a request, a generation session, or another reference entity.

The term “usage condition information” refers to metadata describing allowable use, restrictions, licensing terms, or policy conditions associated with stored visual material data.

The term “response data” refers to digital data transmitted from the server to the user terminal, including at least reference information for acquiring generated visual material data.

The term “reference information for acquisition” refers to information, such as a locator, identifier, or access token, that enables the user terminal to retrieve the stored visual material data from the information storage device.

The term “additional request expressed in a natural language” refers to a subsequent natural language instruction from the user terminal that modifies, refines, or supplements an earlier request.

The term “past request history” refers to stored data representing prior natural language requests, extended prompt sentences, or generation sessions associated with a user.

The term “regenerate the visual material data” refers to a process of invoking a generative AI model again with an updated extended prompt sentence to produce new or modified visual material data.

The term “conformity index” refers to a numerical or categorical measure indicating how closely a generated visual material matches or satisfies a corresponding prompt sentence.

The term “aesthetic evaluation index” refers to a numerical or categorical measure indicating perceived aesthetic quality, attractiveness, or visual appeal of generated visual material.

The term “task-type information of the user” refers to information describing a category of work being performed by the user, such as information-creation work or design work, used to select layouts and dimensions.

The term “wallpaper layout” refers to a screen arrangement and aspect ratio suitable for setting an image as a background on a display surface of a user terminal.

The term “advertising-image layout” refers to a screen arrangement and aspect ratio suitable for use of an image in a promotional or advertising context.

The term “explanatory-graphic layout” refers to a screen arrangement and aspect ratio suitable for images used in explanation, documentation, or instructional content.

The term “decorative-graphic layout” refers to a screen arrangement and aspect ratio suitable for images used primarily for ornamental or decorative purposes.

The term “image dimensions” refers to numerical values defining the size of an image in at least one direction, such as width and height in pixels.

The term “information-creation task” refers to a computer-assisted activity in which a user prepares content such as documents, presentations, or materials incorporating visual elements.

The term “design task” refers to a computer-assisted activity in which a user creates or edits graphical layouts, visual designs, or user interfaces using visual material data.

In one embodiment, a server cooperates with one or more terminals operated by users to implement a system for generating visual material data by using a generative AI model based on a prompt sentence derived from a natural language request and emotion-related information.

The server includes at least one processor, a main memory, a non-volatile storage, a network interface, and access to an information storage device such as a disk array or networked storage service. The server executes an operating system such as a general-purpose server operating system and runs application software modules implementing natural language processing, emotion analysis, prompt construction, generative inference, post-processing, safety checking, and storage management. The server may use one or more hardware accelerators, such as graphics processing units, for generative model inference and certain neural network-based analyses.

The terminal includes an input unit, such as a touch screen, keyboard, and microphone, and an imaging unit such as a digital camera. The terminal further includes a local processor, memory, a display, and a communication interface. The terminal executes a client application or web browser that provides a user interface for inputting natural language requests, for capturing audio and image information of the user, and for displaying or applying generated visual material.

The user operates the terminal to input a natural language request as a prompt sentence. The terminal presents a text field and optionally a voice input control and camera preview. Example prompt sentences include:

“Please generate an advertisement banner with colorful balloons in the blue sky for a summer sale using a cheerful style.”

“I feel sad; generate a calm, soft wallpaper that helps me relax.”

“Draw a minimal, flat illustration of a city skyline at night with a peaceful mood.”

“Create a surprising and powerful poster visual for a new product launch that expresses excitement.”

The terminal converts spoken input to text by transmitting audio signals to a speech recognition service and receiving corresponding textual data. The terminal may also capture face images and short voice segments of the user to serve as emotion-related information. The terminal transmits, to the server, a request message that includes at least: the natural language prompt sentence, user identification data, optional audio and image information, and terminal context information (for example, screen resolution and type of layout desired).

The server stores the received request message in memory in a structured internal representation. In one embodiment, the server represents the request as a composite data structure including fields for raw text, processed tokens, extracted attributes, emotion features, task type, and usage category. The server uses language processing technology executed by the processor to analyze the received prompt sentence. In one embodiment, the server tokenizes the prompt sentence, performs part-of-speech tagging, and applies a dependency parser to derive syntactic relationships. The server then applies rule-based extraction and statistical classification to determine attribute information, including at least a target object, a color attribute, a composition attribute, a usage attribute, and an emotion expression.

The server maps the target object to an internal object category list, such as “beach scene,” “city skyline,” “balloon object,” or “product object,” by computing similarity between phrase embeddings of the prompt sentence and pre-registered category vectors. The server derives the color attribute by identifying color words and by mapping them to color profiles that specify hue ranges, saturation ranges, and brightness levels. The server derives the composition attribute by recognizing phrases that indicate layout (for example, “center text,” “background sky,” “foreground character”) and by mapping them to predefined layout templates and bounding box configurations. The server derives the usage attribute by recognizing words such as “wallpaper,” “banner,” “poster,” or “presentation slide,” and by mapping them to usage categories corresponding to screen aspect ratios and resolution presets. The server derives the emotion expression by locating sentiment-bearing words (for example, “cheerful,” “calm,” “powerful,” “sad”) and mapping them to a discrete or continuous emotion space.

The server also analyzes emotion-related information acquired from the user. In one embodiment, the server uses text analysis of the prompt sentence and additional chat-like inputs to compute sentiment scores using a sentiment classifier trained on labeled text data. The server analyzes audio information by computing acoustic features, such as pitch contour, energy envelope, spectral centroid, and speaking rate, and by feeding these feature vectors into a neural network-based emotion classifier. The server analyzes image information by detecting a facial region using a visual detection algorithm, such as a convolutional feature detector, and by inputting the aligned face image into a convolutional neural network trained to output probabilities over emotion classes such as “happy,” “sad,” “surprised,” “angry,” and “neutral.”

In one implementation, the server fuses results of text analysis, audio analysis, and image analysis by using a weighted averaging or learned fusion network. The server represents each modality as a vector in an emotion embedding space and applies a learned weighting matrix to obtain a fused emotion embedding. The server then selects, as the emotional state, the class label corresponding to the nearest centroid in that embedding space, together with a confidence score.

The server integrates the attribute information and emotional state into an extended prompt sentence. The server constructs an initial machine-oriented prompt sentence using the extracted attribute information, such as “Generate a high-resolution advertising banner of a blue sky with many colorful balloons, with centered sale text.” The server augments this prompt sentence with style information and expression conditions derived from the emotional state. For instance, when the emotional state is “sad,” the server attaches style parameters specifying low saturation, soft gradients, and smooth textures; when the emotional state is “cheerful,” the server sets high saturation, stronger contrast, and dynamic element arrangements. The server encodes these parameters both as textual modifiers in the extended prompt sentence (for example, “in a calm, soft-colored style with low saturation” or “in a bright, vivid style with high saturation and strong contrast”) and as numeric style vectors that are input to the generative AI model.

The server selects a generative AI model from among a plurality of types of generative AI models. The plurality may include, for example, different diffusion-based image generators, auto-regressive image generators, and style-specialized submodels. The server stores metadata for each model, including supported resolutions, typical execution time, memory footprint, and training domain. The server determines which model to select based on the usage attribute and task type. For example, the server can choose a model that is optimized for tall mobile wallpapers for prompts requesting wallpapers, and a model that is optimized for landscape banners for prompts requesting advertisement banners.

The server represents the extended prompt sentence as a vector by using a text encoder implemented as a transformer network. The processor maps each token of the extended prompt sentence to an embedding, applies a stack of multi-head self-attention layers, and produces a final embedding that captures semantic and stylistic information. The server inputs this embedding, as well as the style information vector derived from the emotional state, into the generative AI model.

In one embodiment, the generative AI model is a diffusion model represented by a neural network that iteratively transforms a noise vector into an image latent representation. The server initializes a random latent tensor and applies a sequence of denoising steps parameterized by the extended prompt embedding and style vector. Each step applies a U-shaped convolutional network with cross-attention layers that inject the prompt and style features. The server configures the number of steps and guidance parameters according to the usage category to balance generation quality and inference time. For example, fewer diffusion steps are used for quick previews, and more steps are used for final high-resolution outputs. The server thereby improves computational efficiency by tailoring inference settings to the specific request.

The server reduces redundant generative processing by reusing intermediate representations when the user submits an additional request that refines the original prompt sentence. In one embodiment, the server stores the latent representation and the extended prompt embedding associated with a previous generation in the information storage device. When an additional request modifies the previous prompt by adjusting only certain attributes, the server updates the extended prompt embedding and continues diffusion from an intermediate latent state instead of restarting from pure noise. This reduces the number of required iterations and, consequently, processor cycles and accelerator usage.

The server performs post-processing on the visual material data output from the generative AI model. The server decodes the latent representation into pixel data and then resamples the image to target dimensions based on the usage category. The server adjusts tone via a tone-mapping algorithm that uses histograms or learned mappings to refine brightness and color balance. The server may perform angle-of-view adjustment by cropping or warping the image to align with certain composition constraints, such as centering a subject or aligning text-safe regions. The server performs format conversion by encoding the processed visual data into image file formats, such as a lossless format for graphics or a compressed format for photographic images.

The server executes a safety determination process that uses a separate classifier network and rule-based filters to detect prohibited content or patterns that violate predefined policies. The safety classifier may be a convolutional or transformer-based network that receives the generated image and outputs a probability of containing disallowed content. If the probability exceeds a threshold, the server marks the image as unsafe and either rejects it or subjects it to additional processing. This server-side safety determination reduces the risk that unsafe images are stored or distributed and lowers the burden on user terminals.

The server converts verified images into an image format usable for commercial transactions by associating each file with identification information and usage condition information. The server stores a record in the information storage device that links a generated image to: a request identifier, a user identifier, the extended prompt sentence, the emotion state, a model identifier, and usage conditions. The server configures the information storage device with indexing structures such as hash maps or inverted indices so that images can be efficiently retrieved based on request terms, model, or user attributes. This structured storage improves data management and retrieval performance compared to unstructured storage of raw binary files.

The server transmits response data to the terminal. The response data includes reference information, such as a locator or token, that allows the terminal to retrieve generated images. The terminal obtains the images by accessing the indicated storage endpoints and displays them in a preview interface. The user can inspect multiple candidate images that are ranked or tagged based on conformity and aesthetic indices computed by the server. In one embodiment, the server computes a conformity index by comparing feature embeddings of the generated image to intent features derived from the extended prompt sentence. The server computes an aesthetic index by using a learned aesthetic scoring network. These indices allow the terminal to present higher-quality or more relevant images preferentially, which decreases the number of iterations needed to reach a satisfactory result and thereby reduces total computation and communication.

The terminal can apply generated images directly to device functions. For example, the terminal can set an image as wallpaper through an API provided by the operating system. The terminal can also incorporate generated images into an application layout template, such as a banner region in a graphical user interface. By aligning server-side generation parameters with terminal display constraints, the system reduces client-side resizing and cropping operations and improves perceived performance.

The system improves computer technology by introducing non-conventional, technical processing specific to the computing environment. The server does not simply automate human design tasks but restructures and optimizes computation through several mechanisms: (i) the transformation of ambiguous natural language into structured attribute information, (ii) multi-modal emotion estimation and style parameterization, (iii) dynamic selection among multiple generative AI models based on usage category and content, (iv) reuse of intermediate latent representations for refinement requests, and (v) coordinated image post-processing and storage with metadata. These mechanisms produce a causal improvement in processing efficiency, inference time, storage management, and communication load.

In particular, the extraction of structured attribute information allows the server to generate extended prompt sentences that lead to fewer failed or irrelevant generations, thereby reducing the number of generative model executions per user goal. The emotion-conditioned style vectors enhance generation precision so that the model does not rely solely on text; as a result, fewer user-side revisions are necessary. The dynamic model selection prevents use of overly large models for simple tasks, saving memory and processing resources. The reuse of partial diffusion states accelerates iterative refinement without sacrificing image quality. The structured storage of image data with associated conditions simplifies retrieval and avoids redundant data regeneration, further lowering CPU and accelerator load.

The server implements neural networks with defined architectures and training procedures. In one embodiment, the text encoder and emotion classifier networks are transformer-based models with multiple self-attention layers. The diffusion model includes a U-shaped convolutional network with residual and attention blocks. During training, the server or a training system minimizes a loss function such as mean squared error between predicted and actual noise in diffusion steps, or cross-entropy loss for emotion classification. The training process updates network weights via gradient descent or variants thereof, such as adaptive optimization algorithms. Data augmentation techniques, such as random cropping for images, time-shift for audio, and synonym replacement for text, improve generalization. Because of these concrete architectures and training methods, the generative AI model and the emotion analysis modules exhibit robust behavior on previously unseen prompts, enabling the technical benefits described.

In other embodiments, the server may employ alternative generative AI model architectures, such as auto-regressive image decoders, variational auto-encoders, or hybrid models, while still using the extended prompt sentence and style vector as inputs to control generation. The server may implement the emotion analysis as a multi-task network that jointly predicts emotion and usage category. The server may also adjust the weight of different modalities in emotion fusion based on historical accuracy, thereby further improving the reliability of emotional conditioning.

In still other embodiments, the terminal may carry out a portion of the processing, such as preliminary emotion analysis or caching of style vectors, to reduce bandwidth consumption. The server may compress intermediate data, such as extended prompt embeddings or latent tensors, before storage or transfer, to further reduce storage usage and network load. The system can be adapted to various hardware environments, including cloud-based clusters, on-premise data centers, and edge computing nodes, while maintaining the described data structures and processing flows.

Through these concrete hardware and software configurations, data structures, and algorithmic flows, the server, the terminal, and the user cooperate to realize a system in which a generative AI model, driven by an extended prompt sentence, is integrated with structured natural language processing, multi-modal emotion analysis, dynamic model selection, and layout-aware post-processing. This integration yields measurable technical effects in the form of improved generation accuracy, reduced computational and communication overhead, more efficient storage and retrieval, and optimized application of generated visual material to display and control functions of information processing devices.

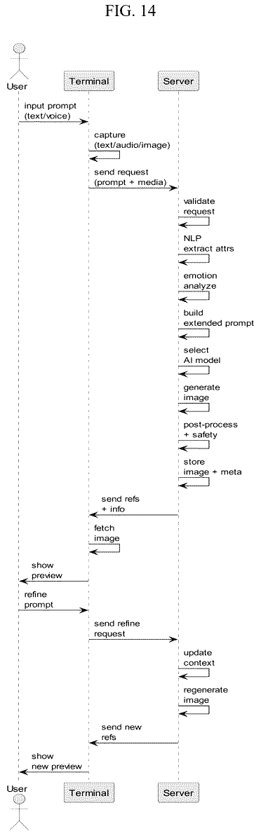

The following describes the processing flow using FIG. 14.

### Step 1

The user operates the terminal and inputs a natural language request. The user types text into a text field or speaks into a microphone, such as the prompt sentence “Please generate an advertisement banner with colorful balloons in the blue sky for a summer sale using a cheerful style” or “I feel sad; generate a calm, soft wallpaper that helps me relax.” The input is raw text characters or audio waveforms. The terminal displays the input, captures the text or audio, and outputs a structured request object containing at least the prompt sentence text, a timestamp, and user identification data.

### Step 2

The terminal converts audio input into text when the user speaks. The input is an audio waveform captured from a microphone. The terminal sends the waveform to a speech recognition component and receives a sequence of recognized words. The terminal replaces or supplements the text field with the recognized prompt sentence and packages it into the request object. The output is an updated request object in which the prompt sentence field is populated with text data, regardless of whether the original input was speech or typing.

### Step 3

The terminal acquires emotion-related sensor data from the user. The input is the terminal's camera feed and microphone signal. The terminal captures a still image of the user's face and records a short audio segment associated with the current request. The terminal compresses the image (for example, into JPEG) and the audio (for example, into a standard audio format) and attaches these as binary payloads to the request object. The output is a composite request message that includes the prompt sentence text, face image data, audio data, and terminal context such as screen resolution and usage indication (for example, wallpaper or banner).

### Step 4

The terminal transmits the composite request message to the server. The input is the composite request message prepared in the previous step. The terminal uses a communication protocol to send the message to a designated server endpoint. The terminal sets headers such as content type and user authorization tokens. The output is a network packet stream delivered to the server, and locally the terminal transitions into a waiting or loading state while it awaits a response.

### Step 5

The server receives the composite request message and performs initial validation. The input is the network packet stream from the terminal. The server reassembles the packets into a message, parses the message structure, and extracts fields such as the prompt sentence, image data, audio data, and user identifiers. The server checks that required fields are present, that the data sizes are within allowed limits, and that file types are expected formats. The server discards malformed data or returns an error if validation fails. The output is a validated internal data structure representing the request, stored in server memory for further processing.

### Step 6

The server performs natural language analysis on the prompt sentence. The input is the text string of the prompt sentence from the validated request structure. The server tokenizes the text into words, performs part-of-speech tagging, and runs syntactic parsing. The server then applies extraction rules and classifiers to identify target objects, color attributes, composition attributes, usage attributes, and emotion expressions. From these results, the server constructs an attribute information structure containing categorical labels (for example, “object: balloons,” “background: sky,” “usage: banner,” “emotion expression: cheerful”). The output is a structured attribute information object associated with the original prompt sentence.

### Step 7

The server performs emotion analysis using text, audio, and image information. The input is the attribute information object, the original prompt sentence, the audio data, and the face image data. The server computes text sentiment features from the prompt sentence, audio features such as pitch and energy from the audio signal, and facial expression features from the image using convolutional or similar feature extractors. The server feeds these features into one or more trained neural network classifiers to estimate probability distributions over emotion classes. The server combines the distributions from each modality into a fused emotion embedding and selects the most probable emotional state (for example, “sad” or “cheerful”) with a confidence measure. The output is an emotional state label and an associated style vector derived from the fused emotion embedding.

### Step 8

The server constructs an extended prompt sentence for generative processing. The input is the original prompt sentence, the attribute information object, and the emotional state with style vector. The server generates a new text sequence that explicitly encodes objects, colors, composition, usage, and emotional style, for example: “Generate a high-resolution advertising banner of a blue sky with many colorful balloons, with large centered sale text, in a bright, cheerful style with high color saturation and strong contrast.” The server also associates numeric parameters, such as desired saturation, brightness, and contrast ranges, with this extended description. The output is an extended prompt sentence and a corresponding parameter set configured for consumption by a generative AI model.

### Step 9

The server selects an appropriate generative AI model and configures inference parameters. The input is the extended prompt sentence, the usage attribute, and the style vector. The server consults model metadata to determine which model is best suited to the task type and usage category, taking into account expected resolution, memory usage, and execution time. The server chooses, for example, a diffusion-based image generator for artwork or a different generator specialized for icons or logos. The server also sets inference parameters such as image size, number of generation steps, and guidance strength based on the usage attribute (for example, 1080×1920 pixels for wallpapers, 1920×1080 pixels for banners). The output is a selected generative AI model instance loaded into the server's processing environment and a configured parameter set for the upcoming generation.

### Step 10

The server encodes the extended prompt sentence into model input representations. The input is the extended prompt sentence and the style vector. The server passes the extended prompt sentence through a text encoder network to obtain a high-dimensional embedding that captures semantic and stylistic information. The server integrates the style vector with this embedding, for example, by concatenation or transformation through a small neural layer, to produce a combined conditioning vector. The output is a conditioning representation suitable for controlling the generative AI model.

### Step 11

The server generates visual material data using the generative AI model. The input is the conditioning representation, the configured inference parameters, and a random seed. The server initializes a latent representation, such as a noise tensor, and iteratively applies the generative AI model's transformation functions. In a diffusion-type model, the server repeatedly applies denoising operations guided by the conditioning representation, gradually refining the noise into a structured latent representation corresponding to an image. At each iteration, the server computes matrix multiplications, convolutions, and non-linear activations. The output is a latent image representation and, after decoding, a raw image tensor representing the generated visual material.

### Step 12

The server optionally generates multiple candidate images and evaluates their relevance. The input is the conditioning representation and the generation parameters. The server repeats the generation process multiple times with different random seeds to obtain several raw image tensors. The server computes a conformity index for each image by comparing internal feature embeddings of the image with feature embeddings of the extended prompt sentence. The server also computes an aesthetic evaluation score using a trained scoring network. The output is a set of images, each associated with a conformity index and an aesthetic index.

### Step 13

The server performs post-processing operations on the generated images. The input is the raw image tensors and their associated indices. The server resizes each image to the target resolution determined by the usage attribute, adjusts composition by cropping or padding to maintain the desired aspect ratio, and corrects tone by applying brightness and color adjustments defined in the style parameters. The server selects one or more images based on the conformity and aesthetic indices, potentially ranking or filtering them. The output is one or more processed images that satisfy usage and stylistic constraints and are ready for format conversion.

### Step 14

The server converts the processed images into commercially usable image formats and performs safety determination. The input is the processed image data. The server encodes each image into a standardized format such as a high-quality compressed format or a lossless graphic format, applying compression with parameters appropriate for commercial use. The server then performs safety checking by feeding the images into a safety classifier that detects prohibited content and by applying rule-based filters. If an image passes safety checks, the server marks it as approved; otherwise, the server rejects or quarantines it. The output is a set of approved, encoded image files designated as suitable for commercial transactions.

### Step 15

The server stores the approved images with associated metadata in an information storage device. The input is the approved image files, the extended prompt sentence, the emotional state, and various identifiers. The server writes the image files to storage and creates metadata records that include user identifiers, request identifiers, model identifiers, conformity and aesthetic indices, usage conditions, and access references. The server organizes these records in an indexable structure to support efficient query and retrieval. The output is persistent storage of images and metadata, along with generated reference information such as URLs or tokens that allow later acquisition.

### Step 16

The server constructs and transmits response data back to the terminal. The input is the stored metadata and reference information produced in the previous step. The server composes a response message that includes references to one or more generated images, information about image resolution and layout, and optional ranking or scores. The server sends this message over the network to the terminal. The output is a response message delivered to the terminal, enabling the terminal to retrieve and present the generated visual material.

### Step 17

The terminal retrieves the generated images and presents them to the user. The input is the response message from the server containing reference information. The terminal uses the references to request the images from the storage location, receives the encoded image files, and decodes them into pixel data suitable for display. The terminal then displays previews or full-size images on the screen, possibly ordered or marked according to the scores provided. The output is a graphical user interface in which the user can view, select, or apply the generated images.

### Step 18

The user reviews the generated images and issues an additional request if refinement is desired. The input is the preview imagery displayed by the terminal and the user's evaluation of that content. The user may select an image and provide feedback in natural language, such as “Make the balloons larger and move the sale text to the bottom,” or “Change the mood to more calm and pastel.” The user inputs this feedback using the same text or voice mechanisms as before. The output is a new prompt sentence, potentially linked to the previous request's identifier, that expresses refinement instructions.

### Step 19

The terminal packages the additional request and sends it to the server as a refinement request. The input is the new prompt sentence and, optionally, a reference to the previous generation. The terminal constructs a refinement message that associates the new prompt sentence with prior request history and may optionally capture new emotion-related data if conditions changed. The terminal sends this refinement message to the server. The output is a refinement request delivered to the server, triggering another cycle of analysis and generation.

### Step 20

The server updates the extended prompt sentence and reuses context for efficient regeneration. The input is the refinement request containing the new prompt sentence and references to past request history. The server retrieves the stored attribute information, emotional state, and, where available, intermediate latent representations from the previous generation. The server analyzes the new prompt sentence to identify changed attributes and updates only those portions of the attribute information and the extended prompt sentence. The server then either continues generation from a stored latent representation or generates afresh with fewer steps based on the modified conditions. The output is a new set of visual material data that reflects the user's refinement while requiring fewer computational resources than a completely new generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

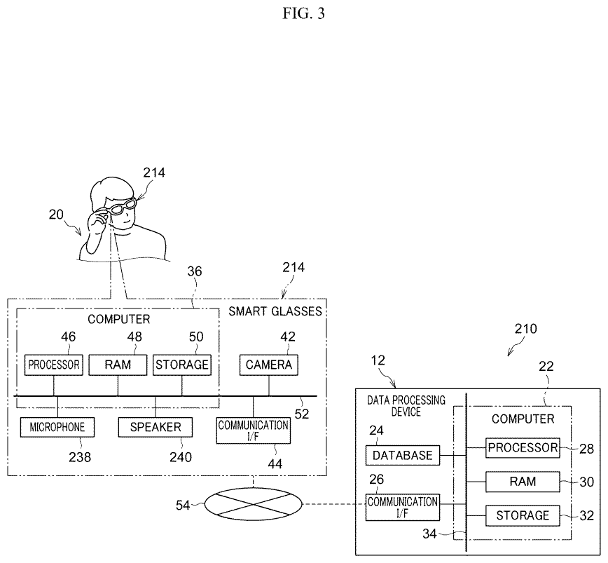

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

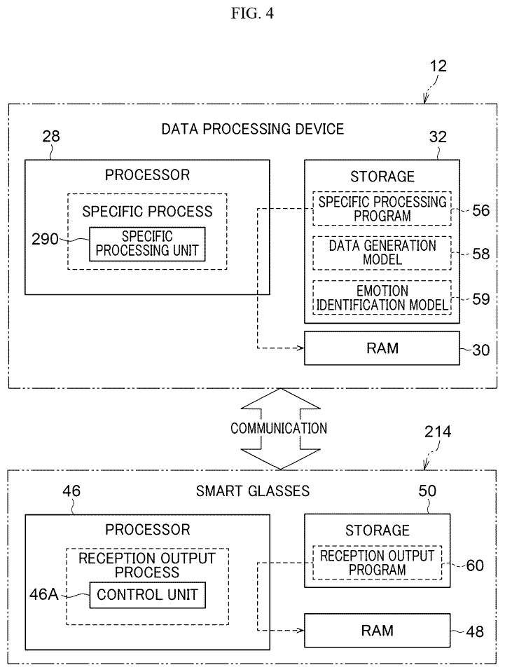

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

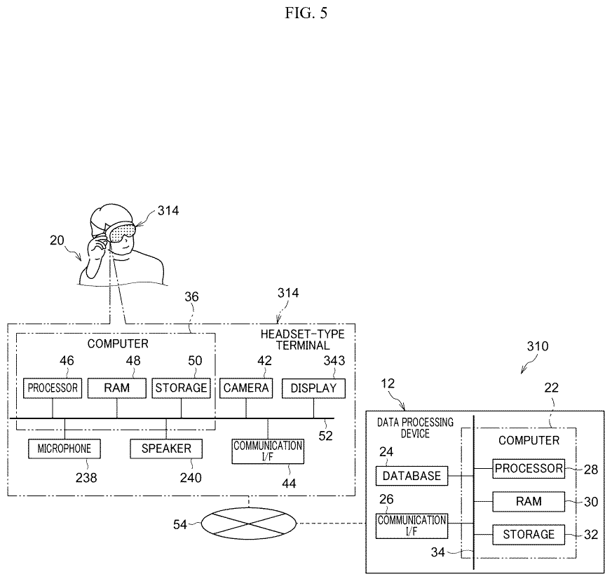

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

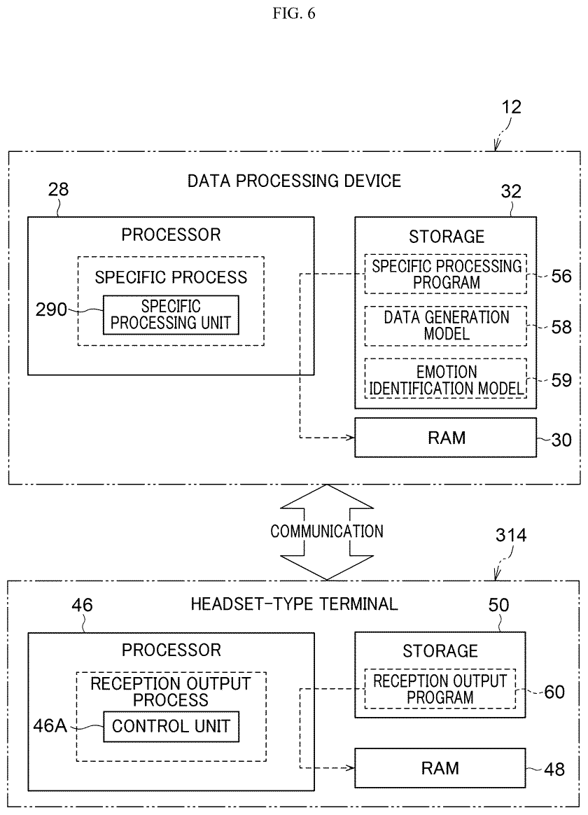

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

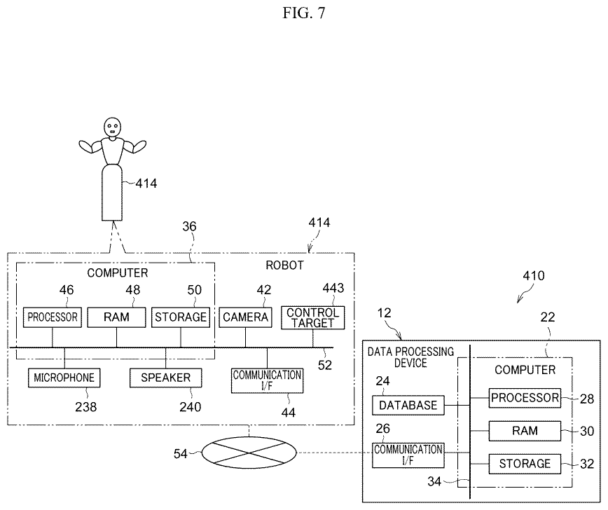

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

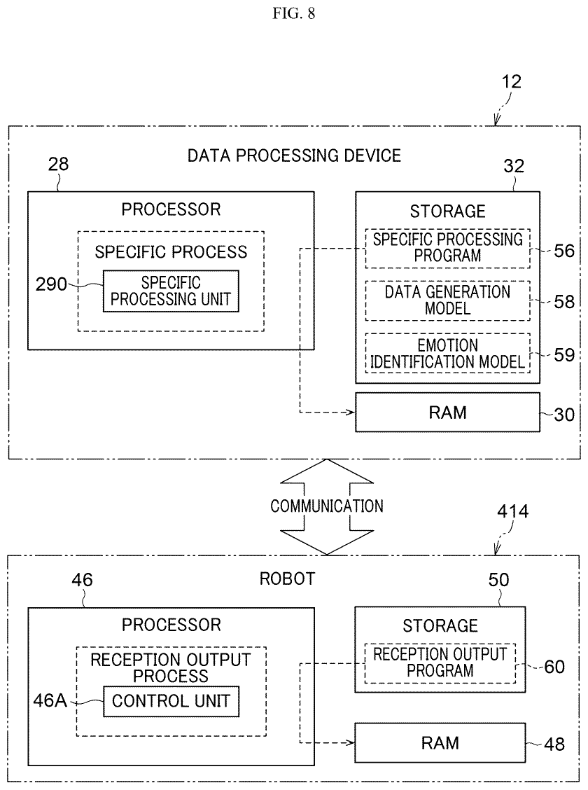

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

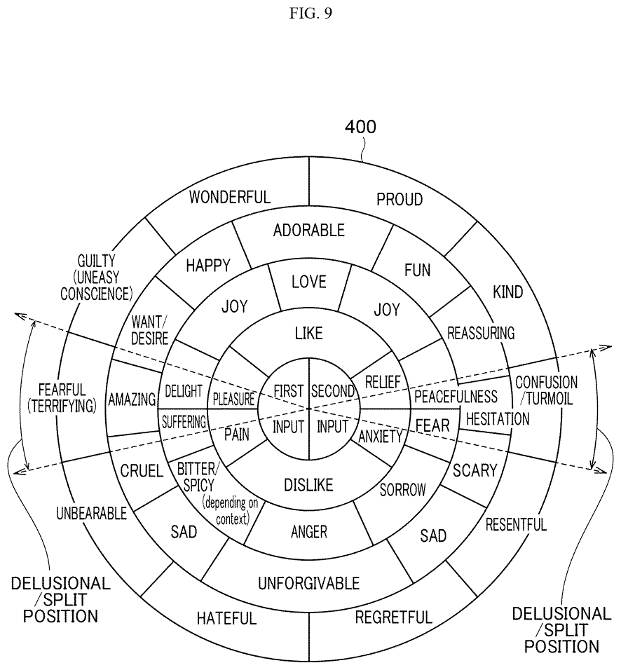

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

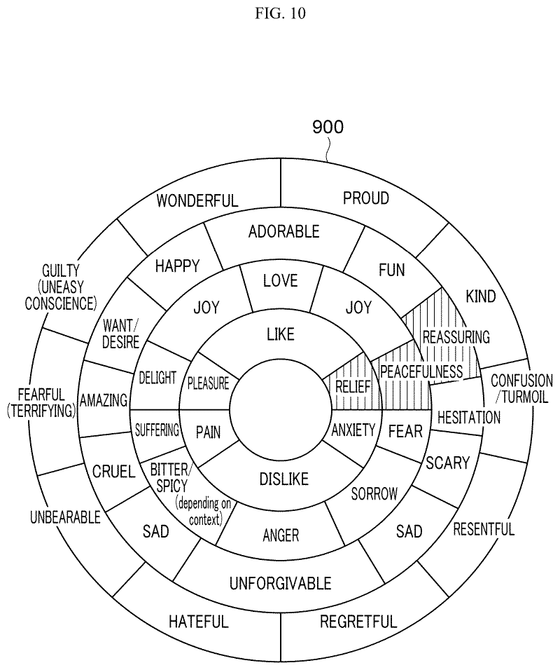

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a network, a request expressed in natural language from a user terminal, and analyze the request expressed in natural language to extract at least a target, an attribute, a representation style, and a usage condition included in the request, normalize a generation language expression based on an extraction result, and generate a prompt sentence for generation processing by applying a predetermined format to the generation language expression, and
generate generation instruction information including the prompt sentence for generation processing and image specification information, and input the generation instruction information to a generative information processing model so as to cause the generative information processing model to generate visual information, and obtain the visual information output from the generative information processing model, and perform post-processing by converting at least a color space, a pixel count, a resolution, and a recording format of the visual information into a commercially usable format in accordance with the usage condition, and
store the post-processed visual information in a storage device, manage information relating to the request expressed in natural language and the prompt sentence in association with the visual information, and provide the visual information to the user terminal in a downloadable form.

### Supplementary 2

The system according to supplementary 1,
wherein the processor is configured to
use, as the generative information processing model, a generative information processing model that receives text as input and outputs image data, input the prompt sentence and the image specification information to the generative information processing model, obtain the image data output from the generative information processing model, and perform the post-processing on the image data.

### Supplementary 3

The system according to supplementary 1,
wherein the processor is configured to
accumulate, in a recording unit, a correspondence among the request expressed in natural language, the prompt sentence, the visual information, and the usage condition, and perform at least one of regeneration, modification, and multiple-candidate presentation of the visual information based on the correspondence so as to improve efficiency of an information creation task or a design task.

### Application Example 1

### Supplementary 1

A system comprising a processor,
wherein the processor is configured to
receive, via a terminal, a request in natural language input by a user and acquire the request as text information,
analyze the text information and, using a generative language model, generate a prompt sentence for causing a visual representation to be generated in response to the request, input the prompt sentence to a generative image model that performs image generation or design generation, and control the generative image model to generate visual representation data based on the prompt sentence,
convert the visual representation data into a commercially usable format by using image processing software to convert at least one of a file format, a resolution, and metadata of the visual representation data, and generate visual material data of a predetermined output format,
transmit the visual material data to the terminal and cause the terminal to output the visual material data in a display format that is presentable to the user, and
acquire, via the terminal, a modification request in natural language from the user regarding the visual material data, update the prompt sentence based on the modification request, and perform a regeneration process by the generative image model so as to iteratively update the visual representation.

### Supplementary 2

The system according to supplementary 1,
wherein the processor is configured to convert audio data into character data by using speech recognition software, and to use the character data as the text information to be input to the generative language model.

### Supplementary 3

The system according to supplementary 1,
wherein the processor is configured to generate a description by combining the request in natural language acquired from the user and the modification request acquired from the user, generate the prompt sentence based on the description, and regenerate the visual representation data by the generative image model based on the prompt sentence so as to improve work efficiency of information creation or design work.

### Example 2

### Supplementary 1

A system comprising a processor,
wherein the processor is configured to
receive, from a terminal operated by a user, a request expressed in natural language,
analyze the request expressed in natural language by language processing so as to extract information indicating at least an object, a background, a style, a resolution, and a use case, and generate a structured prompt sentence for generation on the basis of the extracted information,
select a generative information processing model as a generative AI model on the basis of the structured prompt sentence and image generation conditions, and configure the generative information processing model,
transmit the structured prompt sentence to the generative information processing model and cause the generative information processing model to generate pixel information of visual content by numerical computation,
perform image processing on the generated pixel information, the image processing including at least resolution conversion, image quality correction, encoding format conversion, and color space conversion, so as to convert the generated pixel information into visual content data in a format suitable for business use,
transmit the converted visual content data to the terminal and provide the converted visual content data as information that is visually displayable on the terminal, and
regenerate the structured prompt sentence on the basis of a modification request re-input from the terminal and repeatedly execute processing for generating the visual content data.

### Supplementary 2

The system according to supplementary 1,
wherein the processor is configured to
select, as the generative information processing model, at least one image generation information processing model from among a plurality of types of image generation information processing models in accordance with the extracted use case information, input the structured prompt sentence and the image generation conditions into the selected image generation information processing model, and control the image processing so that visual content data output from the selected image generation information processing model is supplied to the image processing.

### Supplementary 3

The system according to supplementary 1,
wherein the processor is configured to
adjust, in the image processing, at least a resolution, a screen composition, a color scheme, and background information of the visual content data in accordance with a request of the user, and optimize the visual content data so as to improve work efficiency in an information creation task or a design task.

### Application Example 2

### Supplementary 1

A system comprising a processor,
wherein the processor is configured to
receive, from a user terminal, a request expressed in a natural language,
analyze the received request by using language processing technology to extract attribute information including at least a target object, a color attribute, a composition attribute, a usage attribute, and an emotion expression, and generate, on the basis of the attribute information, a prompt sentence for generation processing,
analyze emotion-related information including audio information and image information acquired from the user to estimate an emotional state of the user by using at least one of text analysis, audio analysis, and image analysis,
integrate the attribute information and the emotional state, add style information and expression conditions corresponding to the emotional state to the prompt sentence for generation processing, and generate an extended prompt sentence suitable for a generative AI model,
select, on the basis of the extended prompt sentence, a generative AI model from among a plurality of types of generative AI models according to content of the request and a usage category, and cause the generative AI model to generate visual material data by inputting the extended prompt sentence and the style information to the generative AI model,
perform post-processing on the visual material data output from the generative AI model, the post-processing including at least one of resolution conversion, angle-of-view adjustment, tone correction, format conversion, and safety determination, and convert the visual material data into an image format usable for commercial transactions,
store the converted visual material data in an information storage device in association with identification information and usage condition information, and transmit response data including reference information for acquisition to the user terminal, and
receive, on the basis of the response data, an additional request expressed in a natural language from the user terminal, update the extended prompt sentence by using the additional request and a past request history, and regenerate the visual material data on the basis of the updated extended prompt sentence.

### Supplementary 2

The system according to supplementary 1,
wherein the processor is configured to
calculate, for a plurality of types of visual material data output from the generative AI model, a conformity index with respect to the prompt sentence and an aesthetic evaluation index, and
select or rank the visual material data on the basis of the indices and present the visual material data to the user terminal.

### Supplementary 3

The system according to supplementary 1,
wherein the processor is configured to
determine, on the basis of the emotional state and task-type information of the user, at least one of a wallpaper layout, an advertising-image layout, an explanatory-graphic layout, and a decorative-graphic layout, and corresponding image dimensions suitable for each layout, and automatically place the visual material data in accordance with the determined layout and image dimensions so as to improve efficiency of an information-creation task or a design task.

What is claimed is:

1. A system comprising:
circuitry configured to:
receive, from a client terminal via a packet-switched network, a request expressed in natural language;
analyze the request to extract at least a target object, attribute information, a representation style, and a usage condition, and normalize a generation language expression based on an extraction result;
generate a prompt sentence by applying a predetermined format to the normalized generation language expression, and generate generation instruction information comprising the prompt sentence and specification information;
transmit the generation instruction information to a generative neural network model and cause the generative neural network model to generate visual data based on the generation instruction information;
perform post-processing on the visual data by converting at least one of a color space, a pixel count, a resolution, and a recording format of the visual data into a target format in accordance with the usage condition; and
store the post-processed visual data in a storage medium in association with the request and the prompt sentence, and transmit the post-processed visual data to the client terminal via the packet-switched network.

2. The system according to claim 1, wherein the circuitry is configured to analyze the request by applying a natural language processing model to the request to identify semantic components comprising object descriptions, style descriptors, color preferences, composition directives, and constraint specifications, and to map each identified semantic component to a corresponding field in a structured extraction result.

3. The system according to claim 2, wherein the circuitry is configured to normalize the generation language expression by translating the semantic components from the structured extraction result into standardized terminology compatible with an input vocabulary of the generative neural network model, and to order the standardized terminology according to a priority hierarchy that places the target object and the representation style before secondary attributes.

4. The system according to claim 3, wherein the circuitry is configured to generate the prompt sentence by combining the ordered standardized terminology with the specification information comprising a target resolution, an aspect ratio, and a quality parameter, and to format the prompt sentence as a structured text string conforming to an input template of the generative neural network model.

5. The system according to claim 4, wherein the circuitry is configured to transmit the prompt sentence to the generative neural network model, receive a plurality of candidate visual data outputs from the generative neural network model, evaluate each candidate based on a conformance score computed from a comparison of visual features of each candidate against the semantic components in the structured extraction result, and select a highest-scoring candidate as the visual data.

6. The system according to claim 1, wherein the circuitry is configured to perform the post-processing by executing color space conversion from a source color model to a destination color model specified by the usage condition, applying resolution scaling to match a target pixel count, embedding metadata comprising the prompt sentence and the usage condition into the visual data, and encoding the visual data in the recording format specified by the usage condition.

7. The system according to claim 6, wherein the circuitry is configured to generate a preview version of the post-processed visual data at a reduced resolution, transmit the preview version to the client terminal, and in response to receiving approval data from the client terminal, transmit the full-resolution post-processed visual data.

8. The system according to claim 7, wherein the circuitry is configured to generate a plurality of visual data variants by varying at least one of the representation style, the color space, and the composition directives in the prompt sentence, perform the post-processing on each variant, and transmit the plurality of variants to the client terminal for selection by the user.

9. The system according to claim 1, wherein the circuitry is configured to receive a modification request in natural language from the client terminal regarding the visual data, analyze the modification request to identify change directives, update the prompt sentence by incorporating the change directives while retaining unchanged semantic components from the original request, and cause the generative neural network model to regenerate the visual data based on the updated prompt sentence.

10. The system according to claim 9, wherein the circuitry is configured to maintain a version history comprising the original prompt sentence, each modification request, and the corresponding updated prompt sentence and regenerated visual data, and to enable the client terminal to access any version in the version history.

11. The system according to claim 10, wherein the circuitry is configured to compare the regenerated visual data against the previously generated visual data by computing a difference map highlighting changed regions, and to transmit the difference map to the client terminal together with the regenerated visual data.

12. The system according to claim 1, wherein the circuitry is configured to receive audio data from the client terminal, convert the audio data into text data using a speech recognition model, and use the text data as the request expressed in natural language.

13. The system according to claim 12, wherein the circuitry is configured to apply a language correction model to the text data to resolve ambiguities and grammatical errors introduced during the speech recognition, and to present the corrected text data to the client terminal for confirmation before proceeding with the analysis.

14. The system according to claim 1, wherein the circuitry is configured to accumulate, in the storage medium, a correspondence among the request, the prompt sentence, the visual data, and user selection data indicating which generated visual data the user approved, and to use the accumulated correspondence to adjust prompt generation parameters for subsequent requests from the same user.

15. The system according to claim 14, wherein the circuitry is configured to analyze the accumulated correspondence to identify prompt patterns associated with high user approval rates, and to prioritize the identified prompt patterns when generating prompt sentences for subsequent requests.

16. The system according to claim 1, wherein the circuitry is configured to estimate an emotional state of the user based on linguistic features extracted from the request, and to adjust at least one of the representation style and a tonal quality of the visual data generated by the generative neural network model based on the estimated emotional state.

17. The system according to claim 1, wherein the circuitry is configured to receive template data specifying a layout format from the client terminal, generate the visual data to conform to dimensional constraints of the layout format, and composite the post-processed visual data into the template data to generate a finished output document.

18. A system comprising:
circuitry configured to:
receive, from a client terminal via a packet-switched network, a request expressed in natural language;
analyze the request to extract a target object, attribute information, a representation style, and a usage condition;
generate a prompt sentence based on the extraction result and specification information;
transmit the prompt sentence to a generative neural network model and cause the generative neural network model to generate visual data;
perform post-processing on the visual data by converting at least one of a color space, a resolution, and a recording format;
estimate an emotional state of a user based on the request and adjust a tonal quality of the visual data based on the estimated emotional state; and
transmit the post-processed visual data to the client terminal via the packet-switched network.

19. The system according to claim 18, wherein the circuitry is configured to receive a modification request from the client terminal, update the prompt sentence based on the modification request, and cause the generative neural network model to regenerate the visual data based on the updated prompt sentence.

20. A method performed by circuitry, the method comprising:
receiving, from a client terminal via a packet-switched network, a request expressed in natural language;
analyzing the request to extract a target object, attribute information, a representation style, and a usage condition;
generating a prompt sentence based on the extraction result and specification information;
transmitting the prompt sentence to a generative neural network model and causing the generative neural network model to generate visual data;
performing post-processing on the visual data by converting at least one of a color space, a resolution, and a recording format; and
transmitting the post-processed visual data to the client terminal via the packet-switched network.
